(19) United States
(12) Patent Application Publication
(10) Pub. No.: US 2026/0295560 A1
(43) Pub. Date: Oct. 1, 2026

(54) Superabsorbent Polymers Based on Citric Acid Having Enhanced Biodegradability and Water Absorptivity

(71) Applicant: Covestro (Netherlands) B.V., Geleen (NL)

(72) Inventors: Teunis Frederikus Johannes Veldhuis, Wijhe (NL); Cornelis Eme Koning, Zwolle (NL)

(21) Appl. No.: 19/489,355

(22) PCT Filed: Jul. 23, 2024
(86) PCT No.: PCT/EP2024/070815

§ 371 Date: Dec. 2, 2025

(30) Foreign Application Priority Data
Jul. 31, 2023 (EP) 23188673.0

(51) Int. Cl. B01J 20/26; B01J 20/28; B01J 20/30; C08G 63/06; C08G 63/78

(52) U.S. Cl. CPC B01J 20/262; B01J 20/28016; B01J 20/28047; B01J 20/3085; C08G 63/06; C08G 63/78

(57) ABSTRACT

The invention relates to a superabsorbent polymer including reacted residues of a citric component and a multi-functional component that exhibits a unique combination of enhanced biodegradability and enhanced water absorptivity. The invention further relates to a process for preparing the superabsorbent polymer. The invention further relates to particles including the superabsorbent polymer. The invention further relates to a composition including one or both of the superabsorbent polymer and the particles. The invention further relates to various uses of the superabsorbent polymer, the particles and the composition.

### CROSS-REFERENCE TO RELATED APPLICATIONS

This application is the United States national phase of International Patent Application No. PCT/EP2024/070815 filed Jul. 23, 2024, and claims priority to European Patent Application No. 23188673.0 filed Jul. 31, 2023, the disclosures of which are hereby incorporated by reference in their entireties.

### BACKGROUND

### Technical Field

The invention lies in the field of superabsorbent polymers (SAPs) based on citric acid that is SAPs comprising reacted residues of citric acid in an amount of at least 15 mol % on superabsorbent polymer.

### Description of Related Art

SAPs are polymers that can absorb and retain extremely large amounts of a liquid, e.g. water, organic liquid, relative to their own mass (IUPAC, Compendium of Chemical Terminology, 2^{nd} ed. (the “Gold Book”), compiled by A. D. McNaught and A. Wilkinson, Blackwell Scientific Publications, Oxford (1997). Online version (2019-) created by S. J. Chalk. ISBN 0-9678550-9-8, https://doi.org/10.1351/goldbook.ST07195).

SAPs are usually made of hydrophilic homopolymers or copolymers that form a three-dimensional network of crosslinked polymer chains; thus SAPs are crosslinked polymers; the crosslinking process creates a three-dimensional network of polymer chains that can absorb and retain water through hydrogen bonding with the water molecules forming a gel-like substance. This makes them incredibly versatile and useful in a variety of applications where moisture control is important. They are often preferred over traditional absorbent materials like cotton or paper, as they are able to hold far more moisture. SAPs are commonly used in a wide range of applications, from hygiene products like diapers, sanitary napkins, and feminine products to construction materials, agricultural and horticultural applications where soil conditioning and/or retaining water is key to plant growth, medical applications such as drug delivery systems, wound dressings, contact lenses, or in packaging materials for sensitive electronic components. In addition to their high absorption capacity, superabsorbent polymers also have the ability to control the release of the absorbed fluid. This can be beneficial in applications like wound dressings, where gradual moisture release is needed to promote healing. Construction and engineering industries have also found potential uses for SAPs. In particular, SAPs can be used in self-healing concrete where they act as an internal reservoir for water when cracks appear in the material. Upon activation by the water, these polymers swell and promote the hydration of nearby cement particles, leading to crack filling and healing. Moreover, superabsorbent polymers play a role in environmental management. They can be used to clean up and retain water from oil spills, preventing the spread of pollution. Additionally, they may assist in flood control by absorbing excess water during heavy rainfalls. Overall, superabsorbent polymers are incredibly versatile and have a wide range of uses. They provide an effective solution for moisture control, waste reduction, and improved performance in a variety of products and applications.

Examples of SAPs include sodium polyacrylates, polyacrylamide, polyacrylic acid, polyvinyl alcohol, starch-based SAPs and chitosan-based SAPs as well as cellulose-based SAPs.

SAPs have both positive and negative environmental impacts. On one hand, SAPs can help conserve water, reduce irrigation frequency, enhance soil quality, and mitigate drought stress in agriculture and horticulture. They can also be used for spill control, wastewater treatment, and self-healing concrete. On the other hand, SAPs are mostly derived from non-renewable resources and contribute to the generation of plastic waste including microplastics; for example, SAPs used for disposable hygiene products, such as diapers and sanitary napkins, end up in landfills or incineration. Therefore the use of SAPs raises concerns about the environmental impact of SAPs, particularly when they are disposed of improperly. When SAPs are released into the environment, they can absorb water from soil or bodies of water, potentially causing harm to plants and animals. As such, it is important to properly dispose of products containing SAPs or ensuring that SAPs are able to fast biodegrade. Thus, it is desirable that SAPs are biodegradable since this could attenuate their environmental impact and contribute to a circular economy.

H. J. Kim et al. (Polymer Degradation and Stability, vol. 144, (October 2017) p. 128-136) disclosed SAPs based on citric acid; more particularly it disclosed SAPs consisting of reacted residues of citric acid, monosodium citrate, and one diol which diol was present in an amount of at least 60 mol % on superabsorbent polymer, and wherein the diol was either ethylene glycol, or 1,4-butanediol, or neopentyl glycol, or 1,4-cyclohexane dimethanol. Out of the four tested diols, H. J. Kim et al. promoted 1,4-butanediol as being the best performing diol in terms of water absorptivity (H. J. Kim et al., paragraph 3.1 and relevant figures). H. J. Kim et al. reported that the highest water absorptivity of the disclosed SAPs based on citric acid was achieved for a SAP which consisted of reacted residues of citric acid in an amount of 28 mol % on superabsorbent polymer, monosodium citrate in an amount of 12 mol % on superabsorbent polymer, and 1,4-butanediol in an amount of 60 mol % on superabsorbent polymer; the water absorptivity of this SAP was 829% after 60 min of water absorption time at pH equal to 7 (H. J. Kim et al., p. 133, Table 3, sample code PC_{0.7}N_{0.3}B_{1.5}). However, according to H. J. Kim et al. the reported water absorptivity for this SAP was admittedly not satisfying, thus there was the need for further improvement. In order to increase the water absorptivity of the best disclosed SAPs consisting of reacted residues of citric acid, monosodium citrate, and 1,4-butanediol, H. J. Kim et al., suggested the post-treatment of this SAP having water absorptivity of 829% after 60 min of water absorption time at pH equal to 7 (sample code PC_{0.7}N_{0.3}B_{1.5}), with hexamethylene diisocyanate (HDI) to induce secondary crosslinking created via urethane bonds formed from the reaction of the isocyanate groups of HDI with the hydroxyl groups of the PC_{0.7}N_{0.3}B_{1.5}) at room temperature and at 60° C. (H. J. Kim et al., paragraph 3.3). The SAP with sample code PC_{0.7}N_{0.3}B_{1.5} and post-treated with HDI at room temperature for 1.5 h, exhibited indeed an enhanced water absorptivity (2130% after 60 min of water absorption time at pH equal to 7; H. J. Kim et al., Table 4 and paragraph 3.3) over the non-HDI-treated SAP with sample code PC_{0.7}N_{0.3}B_{1.5} (which was the SAP consisting of reacted residues of citric acid in an amount of 28 mol % on superabsorbent polymer, monosodium citrate in an amount of 12 mol % on superabsorbent polymer, and 1,4-butanediol in an amount of 60 mol % on superabsorbent polymer, not post-treated with HDI at room temperature for 1.5 h). Thus, H. J. Kim et al. suggested: a) the use of 1,4-butanediol in an amount of at least 60 mol % on superabsorbent polymer, in combination with citric acid in an amount of 28 mol % on superabsorbent polymer, and monosodium citrate in an amount of 12 mol % on superabsorbent polymer, to obtain SAPs based on citric acid with a water absorptivity of 829% after 60 min of absorption time at pH equal to 7 (best non-HDI-treated SAP), and b) post-treating said SAP with HDI—at room temperature for 1.5 h—in order to enhance the water absorptivity of the best non-HDI-treated SAP. H. J. Kim et al. was silent—at least—as to: i) the use of a multi-functional component—as the latter is defined in the specification—(actually H. J. Kim et al. promoted the use of 1,4-butanediol), ii) the use of a diol in an amount of at most 50 mol % on superabsorbent polymer, and iii) a SAP based on citric acid that has a rubbery plateau storage modulus at 160° C. let alone of a rubbery plateau storage modulus at 160° C. within a range shown in the specification. Furthermore, H. J. Kim et al. promoted the use of monosodium citrate in amounts of at most 12 mol % on superabsorbent polymer since the best performing SAP of H. J. Kim et al. was the SAP with sample code PC_{0.7}N_{0.3}B_{1.5} post-treated with HDI—at room temperature for 1.5 h—wherein the amount of monosodium citrate was 12 mol % on superabsorbent polymer (the SAP with sample code PC_{0.5}N_{0.5}B_{1.5} post-treated with HDI—at room temperature for 1.5 h); this SAP had a water absorptivity of 2130% whilst a SAP with an amount of monosodium citrate of 20 mol % on superabsorbent polymer had a water absorptivity of 1830% after 60 min of absorption time at pH equal to 7 (sample code PC_{0.5}N_{0.5}B_{1.5} and post-treated with HDI at room temperature for 1.5 h). In addition, H. J. Kim et al. failed to provide for non-HDI-treated SAPs based on citric acid having water absorptivity higher than 829% after 60 min of absorption time at pH equal to 7. Most importantly, H. J. Kim et al. was not concerned with the biodegradability of the disclosed SAPs based on citric acid, let alone on how to enhance it.

Clearly the state-of the-art did not address the environmental concerns associated with the use of SAPs and the generation of plastic waste including microplastics.

It would thus be desirable for a variety of advanced applications especially in the areas of pharmaceutical, biomedical, agricultural and horticultural applications, to obtain SAPs based on citric acid having enhanced biodegradability and enhanced water absorptivity since this would address not only the required enhanced performance in terms of water absorptivity but also the environmental concerns.

However, enhancing the water absorptivity of SAPs based on citric acid, and combining it with enhanced biodegradability poses a serious technical challenge; the state-of-the-art suggests the use of isocyanates in post-treating SAPs based on citric acid to enhance their water absorptivity but at the time of this invention the state-of-the-art was silent as to how to enhance the biodegradability of SAPs based on citric acid and thus address the environmental concerns associated with the use of SAPs.

Therefore, there is a desire for SAPs based on citric acid that would combine enhanced biodegradability and enhanced water absorptivity.

The discussion of documents, acts, materials, devices, articles and the like is included in this specification solely for the purpose of providing a context for the present invention. It is not suggested or represented that any or all of these matters were common general knowledge in the field relevant to the present invention.

### SUMMARY

The invention relates to a superabsorbent polymer comprising reacted residues of a citric component and a multi-functional component that exhibits a unique combination of enhanced biodegradability and enhanced water absorptivity. The invention further relates to a process for preparing the superabsorbent polymer. The invention further relates to particles comprising the superabsorbent polymer. The invention further relates to a composition comprising one or both of the superabsorbent polymer and the particles. The invention further relates to various uses of the superabsorbent polymer, the particles and the composition.

The goal of the invention is to provide for SAPs based on citric acid that would combine enhanced biodegradability and enhanced water absorptivity.

This goal was surprisingly achieved by the superabsorbent polymer as claimed and as disclosed in the specification.

More particularly, it has surprisingly been found that the superabsorbent polymer of the invention exhibited enhanced biodegradability and enhanced water absorptivity.

The superabsorbent polymer of the invention constitutes a major technological advancement for a number of industries especially in connection with pharmaceutical, biomedical, agricultural and horticultural applications, since the superabsorbent polymer of the invention possess a unique and very desirable combination of properties such as enhanced biodegradability and enhanced water absorptivity and at the same time mitigates the environmental concerns associated with the use of SAPs.

The invention is as set out in the claims and as disclosed in the specification. Many other variations and embodiments within the scope of the claims will be apparent to those skilled in the art.

### DETAILED DESCRIPTION

The specification provides definitions for certain terms used in the specification and/or the claims. Any other term used in the specification and/or the claims that is not defined in the specification has the meaning attributed to it by one of ordinary skill in the art.

The term ‘superabsorbent polymer(s)’ (abbreviated as SAP or SAPs in its plural form) as used in the specification means a polymer that is crosslinked (in other words, the polymer comprises a three-dimensional network of crosslinked polymer chains) and is able to absorb water, determined by the Water Absorptivity Method (abbreviated as WAM) as disclosed in the specification, in an amount of at least 300% of its own weight.

The term ‘SAP based on citric acid’ (or ‘SAP based on citric acid’ in its plural form) as used in the specification means a SAP comprising reacted residues of citric acid in an amount of at least 15 mol % on superabsorbent polymer.

The term ‘enhanced biodegradability’ as used in the specification means that the biodegradability (as determined in the specification) is at least 40, preferably at least 50, for example at least 55, for example at least 60%.

The term ‘enhanced water absorptivity’ as used in the specification means that the water absorptivity (as determined in the specification) is at least 1500, preferably at least 1600, more preferably at least 1700, for example at least 1800, for example at least 1900, for example at least 2000, for example at least 2100, for example at least 2200, for example at least 2300, for example at least 2400, for example at least 2500%.

The rubbery plateau storage modulus G′ₚ is defined as the storage modulus G′ at 160° C. and which temperature 160° C. temperature lies on a rubbery plateau. The G′ₚ is determined by Dynamic Mechanical Thermal Analysis as disclosed in the specification.

The term ‘comprising’ as used in the specification means that the list that immediately follows is non-exhaustive and may or may not include any other additional suitable items, for example, one or more additional feature(s), component(s) and/or substituent(s) as appropriate. The term ‘comprising’ is used interchangeably with the term ‘containing’.

The term ‘consisting of’ as used in the specification means that the list that follows is exhaustive and does not include additional items. It is understood that the total sum of any quantities expressed in the specification as percentages cannot (allowing for rounding errors) exceed 100%. However, where a list of components is non-exhaustive, the sum of the percentage for each of such components may be less than 100% to allow a certain percentage for additional amount(s) of any additional component(s) that may not be explicitly described in the specification.

The term ‘acrylate monomer’ as used in the specification means salts, esters, and conjugated bases of acrylic acid. Examples of acrylate monomers include but are not limited to acrylic acid, methyl acrylate, ethyl acrylate, butyl acrylate.

The term ‘methacrylate monomer’ as used in the specification means salts, esters, and conjugated bases of methacrylic acid. Examples of methacrylic monomers include but are not limited to methacrylic acid, methyl methacrylate, ethyl methacrylate, butyl methacrylate, hydroxyethyl methacrylate.

Unless the context indicates otherwise, the plural forms of the terms in the specification are construed as including the singular form and vice versa.

For all upper and lower boundaries of any parameters given in the specification, the boundary value is included in each range for each parameter. All combinations of minimum and maximum values of the parameters described in the specification may be used to define the parameter ranges for various embodiments and preferences of the invention. In the context of the present invention unless stated to the contrary, the disclosure of alternative values for the upper or lower limit of the permitted range of a parameter, coupled with an indication that one of the said values is more highly preferred than the other, is to be construed as an implied statement that each intermediate value of the said parameter, lying in between the more preferred and the less preferred of said alternatives, is itself preferred to said less preferred value and also to each value lying between said less preferred value and said intermediate value.

The decimal separator in numbers (also known as the radix character) is indicated with a period (‘.’).

Certain moieties, species, groups, repeat units, compounds, oligomers, polymers, materials, mixtures, compositions and/or formulations which comprise and/or are used in some or all of the invention as described in the specification may exist as one or more different forms such as any of those in the following non-exhaustive list: stereoisomers (such as enantiomers (e.g. E and/or Z forms), diastereoisomers and/or geometric isomers); tautomers (e.g. keto and/or enol forms). The invention comprises and/or uses all such forms which are effective as defined in the specification.

This section (Detailed Disclosure of the Invention) together with the claims provides for the disclosure of the invention as well as for explicit preferments and embodiments of the claimed invention; thus, the disclosure presented in this section, along with these explicit preferments and embodiments disclosed in this section are within the scope of the claimed invention. For all upper and lower boundaries of any parameters given in this section, the boundary value is included in each range for each parameter. All combinations of minimum and maximum values of the parameters disclosed in this section may be used to define the parameter ranges for various preferments and embodiments of the invention disclosed in this section.

The invention provides for a superabsorbent polymer as described in claim 1. The subject matter of this paragraph is mentioned in the specification as ‘A0’.

More particularly, the invention provides for a superabsorbent polymer which:
has one or more glass transition temperatures, determined by Dynamic Mechanical Thermal Analysis as disclosed in the specification, and each one of the one or more glass transition temperatures is in the range of from and including 10 up to and including 140° C., preferably from and including 10 up to and including 135° C., for example from and including 10 up to and including 130° C., for example from and including 10 up to and including 125° C., for example from and including 10 up to and including 120° C., for example from and including 10 up to and including 115° C., for example from and including 10 up to and including 110° C., from and including 15 up to and including 140° C., for example from and including 15 up to and including 135° C., for example from and including 15 up to and including 130° C., for example from and including 15 up to and including 125° C., for example from and including 15 up to and including 120° C., for example from and including 15 up to and including 115° C., for example from and including 15 up to and including 110° C., for example from and including 20 up to and including 140° C., preferably from and including 20 up to and including 135° C., for example from and including 20 up to and including 130° C., for example from and including 20 up to and including 125° C., for example from and including 20 up to and including 120° C., for example from and including 20 up to and including 115° C., for example from and including 20 up to and including 110° C., for example from and including 30 up to and including 140° C., preferably from and including 30 up to and including 135° C., for example from and including 30 up to and including 130° C., for example from and including 30 up to and including 125° C., for example from and including 30 up to and including 120° C., for example from and including 30 up to and including 115° C., for example from and including 30 up to and including 110° C.,
has a decomposition temperature determined by Thermogravimetric Analysis as disclosed in the specification, of at least 190 and at most 350° C., preferably of at least 190 and at most 320, for example of at least 190 and at most 300° C., for example of at least 190 and at most 290° C.,
has a rubbery plateau storage modulus at 160° C. (abbreviated as G′ₚ), determined by Dynamic Mechanical Thermal Analysis as disclosed in the specification, of at least 30 kPa and at most 5000 kPa, and
comprises, in an amount of at least 80 and at most 100, preferably of at least 85 and at most 100, for example of at least 90 and at most 100, for example of at least 92 and at most 100, for example of at least 95 and at most 100, for example of at least 96, and at most 100, for example of at least 97 and at most 100, for example of at least 98 and at most 100, for example of at least 99 and at most 100 mol % on superabsorbent polymer, reacted residues of a citric component and a multi-functional component,
   wherein
   the citric component is present in an amount of at least 40, preferably at least 45, for example at least 47, for example at least 48, for example at least 49 mol % on superabsorbent polymer, and at most 75, for example at most 70, for example at most 65, for example at most 60, for example at most 59, for example at most 58, for example at most 57, for example at most 56, for example at most 55, for example at most 54, for example at most 53, for example at most 52, for example at most 51 mol % on superabsorbent polymer for example the citric component is present in an amount of at least 40 and at most 60 mol % on superabsorbent polymer, wherein
   the citric component consists of a citrate component and a citric acid component,
   and wherein
   the citrate component is selected from the group consisting of mono-sodium citrate, mono-potassium citrate, mono-silver citrate, mono-lithium citrate, di-sodium citrate, di-potassium citrate, di-silver citrate, di-lithium citrate and mixtures thereof, and is present in an amount, of at least 15, preferably at least 17, more preferably at least 18, for example at least 19, for example at least 20, for example at least 21 mol % on superabsorbent polymer, and at most 50, preferably at most 45, more preferably at most 40, more preferably at most 35, even more preferably at most 32, for example at most 30, for example at most 28, for example at most 27, for example at most 26, for example at most 25, for example at most 24 mol % on superabsorbent polymer, for example the citrate component is present in an amount of at least 18 and at most 40 mol % on superabsorbent polymer, for example the citrate component is present in an amount of at least 18 and at most 40 mol % on superabsorbent polymer,
   and wherein
   the citric acid component is selected from the group consisting of citric acid, citric acid anhydride, citric acid esters, and mixtures thereof, and is present in an amount of at least 15, preferably at least 17, more preferably at least 18, for example at least 19, for example at least 20, for example at least 21 mol % on superabsorbent polymer, and at most 50, preferably at most 45, more preferably at most 40, more preferably at most 35, even more preferably at most 32, for example at most 30, for example at most 28, for example at most 27, for example at most 26, for example at most 25, for example at most 24 mol % on superabsorbent polymer, for example the citric acid component is present in an amount of at least 15 and at most 40 mol % on superabsorbent polymer,
   and wherein
   the multi-functional component is present in an amount of at least 25, for example at least 30, for example at least 40, for example at least 41, for example at least 42, for example at least 43, for example at least 44, for example at least 45, for example at least 46, for example at least 47, for example at least 48, for example at least 49 mol % on superabsorbent polymer, and at most 60, for example at most 55, for example at most 53, for example at most 52, for example at most 51 mol % on superabsorbent polymer,
   and wherein
   the multi-functional component consists of a polyhydroxy component and optionally of a component A which component A consists of one or both of a dihydroxy alcohol component and an amino-hydroxy component,
   and wherein
   the polyhydroxy component is selected from the group consisting of C₃-C₁₀ saturated aliphatic trihydroxy alcohols, C₅-C₁₄ saturated aliphatic tetrahydroxy alcohols, C₄-C₂₄ sugar alcohols, C₃-C₁₀ saturated aliphatic trihydroxy ethers, C₄-C₁₂ saturated aliphatic tetrahydroxy ethers, C₅-C₁₄ saturated aliphatic pentahydroxy ethers, C₆-C₁₆ saturated aliphatic hexahydroxy ethers, and mixtures thereof; preferably the polyhydroxy component is selected from the group consisting of C₃-C₁₀ saturated aliphatic trihydroxy alcohols, C₅-C₁₄ saturated aliphatic tetrahydroxy alcohols, and mixtures thereof; more preferably the polyhydroxy component is selected from the group consisting of glycerol, trimethylolpropane, diglycerol, and mixtures thereof; even more preferably the polyhydroxy component is glycerol,
   and wherein
   the polyhydroxy component is present in an amount of at least 25, for example at least 30, for example at least 40, for example at least 41, for example at least 42, for example at least 43, for example at least 44, for example at least 45, for example at least 46, for example at least 47, for example at least 48, for example at least 49 mol % on superabsorbent polymer, and at most 60, for example at most 55, for example at most 53, for example at most 52, for example at most 51 mol % on superabsorbent polymer,
   and wherein
   the dihydroxy alcohol component is selected from the group consisting of C₂-C₁₂ saturated aliphatic dihydroxy alcohols and mixture thereof; preferably the dihydroxy alcohol component is selected from the group consisting of C₂-C₈ saturated aliphatic dihydroxy alcohols and mixtures thereof; more preferably the dihydroxy alcohol component is selected from the group consisting of C₂-C₆ saturated aliphatic dihydroxy alcohols and mixtures thereof; even more preferably the dihydroxy alcohol component is selected from the group consisting of C₂-C₄ saturated aliphatic dihydroxy alcohols and mixtures thereof; most preferably the dihydroxy alcohol component is selected from the group consisting of 1,2-ethylene glycol, 1,2-propylene glycol, diethylene glycol, triethylene glycol, 1,3-propylene glycol, 1,4-butanediol, 2,3-butanediol, and mixtures thereof; especially the dihydroxy alcohol component is selected from the group consisting of 1,2-ethylene glycol, 1,2-propylene glycol, diethylene glycol, triethylene glycol, 1,3-propylene glycol, and mixtures thereof; more especially the dihydroxy alcohol component is 1,2-ethylene glycol,
   and wherein
   the amino-hydroxy component is selected from the group consisting of C₂-C₁₄ saturated aliphatic secondary amines comprising two hydroxyl groups, C₃-C₂₀ saturated aliphatic tertiary amines comprising three hydroxyl groups, and mixtures thereof; preferably the multi-functional component is selected from the group consisting of C₃-C₁₄ saturated aliphatic secondary amines comprising two hydroxyl groups, C₃-C₂₀ saturated aliphatic tertiary amines comprising three hydroxyl groups, and mixtures thereof; more preferably the multi-functional component is selected from the group consisting of C₄-C₁₄ saturated aliphatic secondary amines comprising two hydroxyl groups, C₃-C₂₀ saturated aliphatic tertiary amines comprising three hydroxyl groups, and mixtures thereof; even more preferably the multi-functional component is selected from the group consisting of C₄-C₁₀ saturated aliphatic secondary amines comprising two hydroxyl groups, C₃-C₁₄ saturated aliphatic tertiary amines comprising three hydroxyl groups, and mixtures thereof; for example preferably the multi-functional component is selected from the group consisting of C₄-C₈ saturated aliphatic secondary amines comprising two hydroxyl groups, C₃-C₁₀ saturated aliphatic tertiary amines comprising three hydroxyl groups, and mixtures thereof; for example the multi-functional component is selected from the group consisting of C₄-C₁₀ saturated aliphatic secondary amines comprising two hydroxyl groups, C₆-C₁₄ saturated aliphatic tertiary amines comprising three hydroxyl groups, and mixtures thereof; for example preferably the multi-functional component is selected from the group consisting of C₄-C₈ saturated aliphatic secondary amines comprising two hydroxyl groups, C₆-C₁₀ saturated aliphatic tertiary amines comprising three hydroxyl groups, and mixtures thereof; for example the multi-functional component is selected from the group consisting of C₄-C₈ saturated aliphatic secondary amines comprising two hydroxyl groups, C₆-C₁₀ saturated aliphatic tertiary amines comprising three hydroxyl groups, and mixtures thereof; for example the multi-functional component is selected from the group consisting of C₄-saturated aliphatic secondary amines comprising two hydroxyl groups, C₆-saturated aliphatic tertiary amines comprising three hydroxyl groups, and mixtures thereof; for example the multi-hydroxy component is selected from the group consisting of diethanolamine, dipropanolamine, diisopropanolamine, and mixtures thereof;
   most preferably the multi-functional component is diethanolamine.
      The subject matter of this paragraph is mentioned in the specification as ‘A1’.

Preferably, the superabsorbent polymer is as disclosed in any one of A0 to A1 or as in any combination derived from the disclosure in this section and the entire specification including the claims, wherein the citrate component is selected from the group consisting of mono-sodium citrate, mono-potassium citrate, mono-silver citrate, mono-lithium citrate, di-sodium citrate, di-potassium citrate, di-silver citrate, and mixtures thereof, for example the citrate component is selected from the group consisting of mono-sodium citrate, mono-potassium citrate, mono-silver citrate, mono-lithium citrate, di-sodium citrate, di-potassium citrate, and mixtures thereof, for example the citrate component is selected from the group consisting of mono-sodium citrate, mono-potassium citrate, mono-silver citrate, mono-lithium citrate, di-sodium citrate, and mixtures thereof, for example the citrate component is selected from the group consisting of mono-sodium citrate, mono-potassium citrate, mono-silver citrate, mono-lithium citrate, and mixtures thereof, for example the citrate component is selected from the group consisting of mono-sodium citrate, mono-potassium citrate, mono-silver citrate, and mixtures thereof, for example the citrate component is selected from the group consisting of mono-sodium citrate, mono-potassium citrate, and mixtures thereof, for example the citrate component is mono-sodium citrate. The subject matter of this paragraph is mentioned in the specification as ‘A2’.

Preferably the superabsorbent polymer is as disclosed in any one of A0 to A2 or as in any combination derived from the disclosure in this and the entire specification including the claims, wherein the G′ₚ is at least at least 30 and at most 4500, for example at least 30 and at most 4000, for example at least 30 and at most 3500, for example at least 30 and at most 3000, for example at least 30 and at most 2500, for example at least 30 and at most 2000, for example at least 30 and at most 1500, for example at least 30 and at most 1000, for example at least 30 and at most 900, for example at least 30 and at most 800, for example at least 30 and at most 700, for example at least 30 and at most 600, for example at least 30 and at most 500, for example at least 30 and at most 400, for example at least 30 and at most 300, for example at least 40 and at most 5000, for example at least 40 and at most 4500, for example at least 40 and at most 4000, for example at least 40 and at most 3500, for example at least 40 and at most 3000, for example at least 40 and at most 2500, for example at least 40 and at most 2000, for example at least 40 and at most 1500, for example at least 40 and at most 1000, for example at least 40 and at most 900, for example at least 40 and at most 800, for example at least 40 and at most 700, for example at least 40 and at most 600, for example at least 40 and at most 500, for example at least 40 and at most 400, for example at least 40 and at most 300, for example at least 50 and at most 5000, for example at least 50 and at most 4500, for example at least 50 and at most 4000, for example at least 50 and at most 3500, for example at least 50 and at most 3000, for example at least 50 and at most 2500, for example at least 50 and at most 2000, for example at least 50 and at most 1500, for example at least 50 and at most 1000, for example at least 50 and at most 900, for example at least 50 and at most 800, for example at least 50 and at most 700, for example at least 50 and at most 600, for example at least 50 and at most 500, for example at least 50 and at most 400, for example at least 50 and at most 300, for example at least 60 and at most 5000, for example at least 60 and at most 4500, for example at least 60 and at most 4000, for example at least 60 and at most 3500, for example at least 60 and at most 3000, for example at least 60 and at most 2500, for example at least 60 and at most 2000, for example at least 60 and at most 1500, for example at least 60 and at most 1000, for example at least 60 and at most 900, for example at least 60 and at most 800, for example at least 60 and at most 700, for example at least 60 and at most 600, for example at least 60 and at most 500, for example at least 60 and at most 400, for example at least 60 and at most 300, for example at least 70 and at most 5000, for example at least 70 and at most 4500, for example at least 70 and at most 4000, for example at least 70 and at most 3500, for example at least 70 and at most 3000, for example at least 70 and at most 2500, for example at least 70 and at most 2000, for example at least 70 and at most 1500, for example at least 70 and at most 1000, for example at least 70 and at most 900, for example at least 70 and at most 800, for example at least 70 and at most 700, for example at least 70 and at most 600, for example at least 70 and at most 500, for example at least 70 and at most 400, for example at least 70 and at most 300, for example at least 80 and at most 5000, for example at least 80 and at most 4500, for example at least 80 and at most 4000, for example at least 80 and at most 3500, for example at least 80 and at most 3000, for example at least 80 and at most 2500, for example at least 80 and at most 2000, for example at least 80 and at most 1500, for example at least 80 and at most 1000, for example at least 80 and at most 900, for example at least 80 and at most 800, for example at least 80 and at most 700, for example at least 80 and at most 600, for example at least 80 and at most 500, for example at least 80 and at most 400, for example at least 80 and at most 300, for example at least 90 and at most 5000, for example at least 90 and at most 4500, for example at least 90 and at most 4000, for example at least 90 and at most 3500, for example at least 90 and at most 3000, for example at least 90 and at most 2500, for example at least 90 and at most 2000, for example at least 90 and at most 1500, for example at least 90 and at most 1000, for example at least 90 and at most 900, for example at least 90 and at most 800, for example at least 90 and at most 700, for example at least 90 and at most 600, for example at least 90 and at most 500, for example at least 90 and at most 400, for example at least 90 and at most 300 kPa. The subject matter of this paragraph is mentioned in the specification as ‘A3’.

Preferably the superabsorbent polymer is as disclosed in any one of A0 to A3 or as in any combination derived from the disclosure in this section and the entire specification including the claims, wherein the multi-functional component consists of a polyhydroxy component and a component A which component A consists of a dihydroxy alcohol component and an amino-hydroxy component. The subject matter of this paragraph is mentioned in the specification as ‘A4’.

Preferably the superabsorbent polymer is as disclosed in any one of A0 to A3 or as in any combination derived from the disclosure in this section and the entire specification including the claims, wherein the multi-functional component consists of a polyhydroxy component and a component A which component A consists of a dihydroxy alcohol component. The subject matter of this paragraph is mentioned in the specification as ‘A5’.

Preferably the superabsorbent polymer is as disclosed in any one of A0 to A3 or as in any combination derived from the disclosure in this section and the entire specification including the claims, wherein the multi-functional component consists of a polyhydroxy component. The subject matter of this paragraph is mentioned in the specification as ‘A6’.

Preferably the superabsorbent polymer is as disclosed in any one of A0 to A3 or as in any combination derived from the disclosure in this section and the entire specification including the claims, wherein the multi-functional component consists of an amino-hydroxy component. The subject matter of this paragraph is mentioned in the specification as ‘A7’.

Preferably the superabsorbent polymer is as disclosed in any one of A0 to A7 or as in any combination derived from the disclosure in this section and the entire specification including the claims, wherein the superabsorbent polymer does not comprise a reacted residue or any combination of reacted residues of an isocyanate, a fatty acid, a monosaccharide, an oligosaccharide, a polysaccharide (e.g. starch, carrageenan), an acrylate, a methacrylate, a polyacrylate, a polymethacrylate, a poly(acrylate-methacrylate), acrylamide, maleic anhydride, a glyceride, cellulose, chitosan, silk fibroin, hyaluronic acid, fibrin, collagen, xanthan, alginate, and pectin. The subject matter of this paragraph is mentioned in the specification as ‘A8’.

Preferably the superabsorbent polymer is as disclosed in any one of A0 to A7 or as in any combination derived from the disclosure in this section and the entire specification including the claims, wherein the superabsorbent polymer does not comprise a reacted residue of an isocyanate. The subject matter of this paragraph is mentioned in the specification as ‘A9’.

Preferably the superabsorbent polymer is as disclosed in any one of A0 to A7 or as in any combination derived from the disclosure in this section and the entire specification including the claims, wherein the superabsorbent polymer does not comprise a reacted residue of a fatty acid. The subject matter of this paragraph is mentioned in the specification as ‘A10’. Preferably the superabsorbent polymer is as disclosed in any one of A0 to A7 or as in any combination derived from the disclosure in this section and the entire specification including the claims, wherein the superabsorbent polymer does not comprise a reacted residue of a monosaccharide. The subject matter of this paragraph is mentioned in the specification as ‘A11’.

Preferably the superabsorbent polymer is as disclosed in any one of A0 to A7 or as in any combination derived from the disclosure in this section and the entire specification including the claims, wherein the superabsorbent polymer does not comprise a reacted residue of an oligosaccharide. The subject matter of this paragraph is mentioned in the specification as

‘A12’.

Preferably the superabsorbent polymer is as disclosed in any one of A0 to A7 or as in any combination derived from the disclosure in this section and the entire specification including the claims, wherein the superabsorbent polymer does not comprise a reacted residue of a polysaccharide (e.g. starch, carrageenan). The subject matter of this paragraph is mentioned in the specification as ‘A13’.

Preferably the superabsorbent polymer is as disclosed in any one of A0 to A7 or as in any combination derived from the disclosure in this section and the entire specification including the claims, wherein the superabsorbent polymer does not comprise a reacted residue of an acrylate monomer. The subject matter of this paragraph is mentioned in the specification as

‘A14’.

Preferably the superabsorbent polymer is as disclosed in any one of A0 to A7 or as in any combination derived from the disclosure in this section and the entire specification including the claims, wherein the superabsorbent polymer does not comprise a reacted residue of a methacrylate monomer. The subject matter of this paragraph is mentioned in the specification as ‘A15’.

Preferably the superabsorbent polymer is as disclosed in any one of A0 to A7 or as in any combination derived from the disclosure in this section and the entire specification including the claims, wherein the superabsorbent polymer does not comprise a reacted residue of a polyacrylate. The subject matter of this paragraph is mentioned in the specification as ‘A16’. Preferably the superabsorbent polymer is as disclosed in any one of A0 to A7 or as in any combination derived from the disclosure in this section and the entire specification including the claims, wherein the superabsorbent polymer does not comprise a reacted residue of a polymethacrylate. The subject matter of this paragraph is mentioned in the specification as ‘A17’.

Preferably the superabsorbent polymer is as disclosed in any one of A0 to A7 or as in any combination derived from the disclosure in this section and the entire specification including the claims, wherein the superabsorbent polymer does not comprise a reacted residue of a poly(acrylate-methacrylate). The subject matter of this paragraph is mentioned in the specification as ‘A18’.

Preferably the superabsorbent polymer is as disclosed in any one of A0 to A7 or as in any combination derived from the disclosure in this section and the entire specification including the claims, wherein the superabsorbent polymer does not comprise a reacted residue of acrylamide. The subject matter of this paragraph is mentioned in the specification as ‘A19’. Preferably the superabsorbent polymer is as disclosed in any one of A0 to A7 or as in any combination derived from the disclosure in this section and the entire specification including the claims, wherein the superabsorbent polymer does not comprise a reacted residue of maleic anhydride. The subject matter of this paragraph is mentioned in the specification as ‘A20’.

Preferably the superabsorbent polymer is as disclosed in any one of A0 to A7 or as in any combination derived from the disclosure in this section and the entire specification including the claims, wherein the superabsorbent polymer does not comprise a reacted residue of a glyceride. The subject matter of this paragraph is mentioned in the specification as ‘A21’.

Preferably the superabsorbent polymer is as disclosed in any one of A0 to A7 or as in any combination derived from the disclosure in this section and the entire specification including the claims, wherein the superabsorbent polymer does not comprise a reacted residue of cellulose. The subject matter of this paragraph is mentioned in the specification as ‘A22’.

Preferably the superabsorbent polymer is as disclosed in any one of A0 to A7 or as in any combination derived from the disclosure in this section and the entire specification including the claims, wherein the superabsorbent polymer does not comprise a reacted residue of chitosan. The subject matter of this paragraph is mentioned in the specification as ‘A23’.

Preferably the superabsorbent polymer is as disclosed in any one of A0 to A7 or as in any combination derived from the disclosure in this section and the entire specification including the claims, wherein the superabsorbent polymer does not comprise a reacted residue of silk fibroin. The subject matter of this paragraph is mentioned in the specification as ‘A24’.

Preferably the superabsorbent polymer is as disclosed in any one of A0 to A7 or as in any combination derived from the disclosure in this section and the entire specification including the claims, wherein the superabsorbent polymer does not comprise a reacted residue of hyaluronic acid. The subject matter of this paragraph is mentioned in the specification as ‘A25’.

Preferably the superabsorbent polymer is as disclosed in any one of A0 to A7 or as in any combination derived from the disclosure in this section and the entire specification including the claims, wherein the superabsorbent polymer does not comprise a reacted residue of fibrin. The subject matter of this paragraph is mentioned in the specification as ‘A26’.

Preferably the superabsorbent polymer is as disclosed in any one of A0 to A7 or as in any combination derived from the disclosure in this section and the entire specification including the claims, wherein the superabsorbent polymer does not comprise a reacted residue of collagen. The subject matter of this paragraph is mentioned in the specification as ‘A27’.

Preferably the superabsorbent polymer is as disclosed in any one of A0 to A7 or as in any combination derived from the disclosure in this section and the entire specification including the claims, wherein the superabsorbent polymer does not comprise a reacted residue of xanthan. The subject matter of this paragraph is mentioned in the specification as ‘A28’.

Preferably the superabsorbent polymer is as disclosed in any one of A0 to A7 or as in any combination derived from the disclosure in this section and the entire specification including the claims, wherein the superabsorbent polymer does not comprise a reacted residue of alginate. The subject matter of this paragraph is mentioned in the specification as ‘A29’.

Preferably the superabsorbent polymer is as disclosed in any one of A0 to A7 or as in any combination derived from the disclosure in this section and the entire specification including the claims, wherein the superabsorbent polymer does not comprise a reacted residue of pectin. The subject matter of this paragraph is mentioned in the specification as ‘A30’.

Preferably the superabsorbent polymer is as disclosed in any one of A0 to A30 or as in any combination derived from the disclosure in this section and the entire specification including the claims, wherein the superabsorbent polymer consists of reacted residues of the citric component and the multi-functional component (or equally the superabsorbent polymer consists of reacted residues of the citric component and the multi-functional component that is the aggregate amount of reacted residues of the citric component and the multi-functional component is equal to 100 mol % on superabsorbent polymer). The subject matter of this paragraph is mentioned in the specification as ‘A31’.

In an embodiment of the invention, there is provided a process for obtaining the superabsorbent polymer as the latter is disclosed in any one of A0 to A31 or as in any combination derived from the disclosure in this section and the entire specification including the claims, wherein the process comprises the steps of:
a) providing at least a citric component and a multi-functional component and optionally one or both of water and a polycondensation catalyst, preferably a citric component and a multi-functional component, water and a polycondensation catalyst, more preferably a citric component and a multi-functional component and a polycondensation catalyst, to afford a mixture,
b) mixing the mixture in a reaction vessel and polycondensing—optionally applying vacuum—the mixture by heating at a temperature ranging from 110 to 180° C., preferably from 110 to 170° C., more preferably from 110 to 160° C., for example from 110 to 150° C., for example from 120 to 180° C., for example from 120 to 170° C., for example from 120 to 160° C., for example from 120 to 150° C., for example from 125 to 180° C., for example from 125 to 170° C., for example from 125 to 160° C., for example from 125 to 150° C., for example from 130 to 180° C., for example from 130 to 170° C., for example from 130 to 160° C., for example from 130 to 150° C., for a time till the shear viscosity determined by the ISO 3219-2:2021 as disclosed in the specification, is 50±20, preferably 50±10 Pa·s,
c) removing the mixture out from the vessel [and if vacuum is applied in step b) removing also the vacuum at this time], by pouring the mixture into another vessel which another vessel is preferably at a temperature of at most 100, preferably at most 80, more preferably at most 60, even more preferably at most 40, for example at most 30° C., and allow it to cool down to obtain a solidified precursor polymer,
d) collecting the precursor polymer,
e) optionally storing the precursor polymer preferably at a temperature of at most 40, more preferably at most 30° C., either in an inert gas e.g. nitrogen, helium atmosphere, or under vacuum, or under vacuum in an inert gas e.g. nitrogen, helium atmosphere,
f) heat-treating the precursor polymer, optionally under vacuum,
   at a temperature of at least 120 and at most 180° C., preferably at a temperature of at least 120 and at most 175° C., for example at a temperature of at least 120 and at most 170° C., for example at a temperature of at least 130 and at most 175° C., for example at a temperature of at least 130 and at most 170° C., for example at a temperature of at least 140 and at most 175° C., for example at a temperature of at least 140 and at most 170° C., for example at a temperature of at least 150 and at most 175° C., for example at a temperature of at least 150 and at most 170° C., for example at a temperature of at least 160 and at most 175° C., for example at a temperature of at least 160 and at most 170° C., for example at 170° C.; and
   preferably for at least 15, more preferably at least 30, even more preferably at least 60, for example at least 90, for example at least 120, for example at least 150, for example at least 180, for example at least 240 min, for example at least 15 and at most 300, for example at least 30 and at most 300, for example at least 60, and at most 300, for example at least 90 and at most 300, for example at least 120 and at most 300, for example at least 15 and at most 240, for example at least 30 and at most 240, for example at least 60 and at most 240, for example at least 90 and at most 240, for example at least 120 and at most 240, for example at least 15 and at most 180, for example at least 30 and at most 180, for example at least 60 and at most 180, for example at least 90 and at most 180, for example at least 120 and at most 180, for example at least 15 and at most 120, for example at least 30 and at most 120, for example at least 60 and at most 120, for example at least 90 and at most 120, for example for 120 min, for example at a temperature of 170° C. for 120 min, to afford the superabsorbent polymer,
g) optionally pulverize the superabsorbent polymer,
h) optionally washing the superabsorbent polymer with excess water, for example for at least 6, for example at least 12 h, for example at least 24 h, then removing the water, for example by filtration, and then drying the superabsorbent polymer, optionally under vacuum, preferably at a temperature of at most 90, more preferably at most 80, even more preferably at most 60, for example at most 50, for example at most 40° C., for example in the range of 40 to 60° C., and afterwards optionally pulverizing the superabsorbent polymer.

The subject matter of this paragraph is mentioned in the specification as ‘A32’.

Preferably the process is as disclosed in A32 or as in any combination derived from the disclosure in this section and the entire specification including the claims, wherein the shear viscosity is being monitored at regular and frequent time intervals by sampling of the reaction mixture. The subject matter of this paragraph is mentioned in the specification as ‘A33’.

In an embodiment of the invention, there are provided particles comprising the superabsorbent polymer as the latter is disclosed in any one of A0 to A31 or the superabsorbent polymer obtained by the process as disclosed in any one of A32 to A33, or as in any combination derived from the disclosure in this section and the entire specification including the claims. The subject matter of this paragraph is mentioned in the specification as ‘A34’.

Preferably the particles are as disclosed in A34 or as in any combination derived from the disclosure in this section and the entire specification including the claims, wherein 10 wt % of the particles have a particle size determined by sieve analysis as disclosed in the specification, of at most 0.20, preferably at most 0.15, more preferably at most 0.10 mm. The subject matter of this paragraph is mentioned in the specification as ‘A35’.

Preferably the particles are as disclosed in A34 or as in any combination derived from the disclosure in this section and the entire specification including the claims, wherein 90 wt % of the particles have a particle size determined by sieve analysis as disclosed in the specification, of at most at most 5.0, preferably at most 3.0, more preferably at most 2.5, even more preferably at most 2.0 mm. The subject matter of this paragraph is mentioned in the specification as ‘A36’.

Preferably the particles are as disclosed in A34 or as in any combination derived from the disclosure in this section and the entire specification including the claims, wherein 10 wt % of the particles have a particle size determined by sieve analysis as disclosed in the specification, of at most 0.20, preferably at most 0.15, more preferably at most 0.10 mm, and wherein 90 wt % of the particles have a particle size determined by sieve analysis as disclosed in the specification, of at most at most 5.0, preferably at most 3.0, more preferably at most 2.5, even more preferably at most 2.0 mm. The subject matter of this paragraph is mentioned in the specification as ‘A37’.

Preferably the particles are as disclosed in any one of A34 to A37 or as in any combination derived from the disclosure in this section and the entire specification including the claims, wherein the particles comprise at least 10, preferably at least 20, for example at least 30, for example at least 40, for example at least 50, for example at least 60, for example at least 70, for example at least 80, for example at least 90, for example at least 95 wt % on particles, the superabsorbent polymer as the latter is disclosed in any one of A0 to A31, or the superabsorbent polymer obtained by the process as disclosed in any one of A32 to A33, or as in any combination derived from the disclosure in this section and the entire specification including the claims. The subject matter of this paragraph is mentioned in the specification as ‘A38’.

Preferably the particles are as disclosed in any one of A34 to A37 or as in any combination derived from the disclosure in this section and the entire specification including the claims, wherein the particles consist of the superabsorbent polymer as the latter is disclosed in any one of A0 to A31 or the superabsorbent polymer obtained by the process as disclosed in any one of A32 to A33, or as in any combination derived from the disclosure in this section and the entire specification including the claims. The subject matter of this paragraph is mentioned in the specification as ‘A39’.

In an embodiment of the invention, there is provided a composition comprising: a) one or both of the superabsorbent polymer as the latter is disclosed in any one of A0 to A31 or as in any combination derived from the disclosure in this section and the entire specification including the claims, and the particles as the latter are disclosed in any one of A34 to A39 or as in any combination derived from the disclosure in this section and the entire specification including the claims, and b) another ingredient. The subject matter of this paragraph is mentioned in the specification as ‘A40’.

Preferably, the composition is as disclosed in any A40 or as in any combination derived from the disclosure in this section and the entire specification including the claims, comprises one or both of the superabsorbent polymer as the latter is disclosed in any one of A0 to A31 or as in any combination derived from the disclosure in this section and the entire specification including the claims, and the particles as the latter are disclosed in any one of A34 to A39 or as in any combination derived from the disclosure in this section and the entire specification including the claims, in an amount of at least 0.01 and at most 99.99 wt % on composition, preferably in an amount of at least 0.01 and at most 90 wt % on composition, and the another ingredient in an amount of at least 0.01 and at most 99.99 wt % on composition, preferably in an amount of at least 10 and at most 99.99 wt % on composition. The subject matter of this paragraph is mentioned in the specification as ‘A41’.

Preferably, the composition is as disclosed in any one of A40 to A41 or as in any combination derived from the disclosure in this section and the entire specification including the claims, wherein the another ingredient is a liquid at 23° C. and 1 atm (=101325 Pa). The subject matter of this paragraph is mentioned in the specification as ‘A42’.

Preferably, the composition is as disclosed in any one of A40 to A42 or as in any combination derived from the disclosure in this section and the entire specification including the claims, wherein the another ingredient is water. The subject matter of this paragraph is mentioned in the specification as ‘A43’.

Preferably, the composition is as disclosed in any one of A40 to A43 or as in any combination derived from the disclosure in this section and the entire specification including the claims, wherein the composition is a gel composition. The subject matter of this paragraph is mentioned in the specification as ‘A44’.

Preferably, the composition is as disclosed in any one of A40 to A44 or as in any combination derived from the disclosure in this section and the entire specification including the claims, wherein the composition is a hydrogel composition. The subject matter of this paragraph is mentioned in the specification as ‘A45’.

Preferably, the composition is as disclosed in any one of A40 to A45 or as in any combination derived from the disclosure in this section and the entire specification including the claims, wherein the composition does not comprise any one of or any combination of an isocyanate, a fatty acid, a monosaccharide, an oligosaccharide, a polysaccharide (e.g. starch, carrageenan), an acrylate, a methacrylate, a polyacrylate, a polymethacrylate, a poly(acrylate-methacrylate), acrylamide, maleic anhydride, a glyceride, cellulose, chitosan, silk fibroin, hyaluronic acid, fibrin, collagen, xanthan, alginate, and pectin. The subject matter of this paragraph is mentioned in the specification as ‘A46’.

Preferably, the composition is as disclosed in any one of A40 to A45 or as in any combination derived from the disclosure in this section and the entire specification including the claims, wherein the composition does not comprise an isocyanate. The subject matter of this paragraph is mentioned in the specification as ‘A47’.

Preferably, the composition is as disclosed in any one of A40 to A45 or as in any combination derived from the disclosure in this section and the entire specification including the claims, wherein the composition does not comprise a fatty acid. The subject matter of this paragraph is mentioned in the specification as ‘A48’.

Preferably, the composition is as disclosed in any one of A40 to A45 or as in any combination derived from the disclosure in this section and the entire specification including the claims, wherein the composition does not comprise a monosaccharide. The subject matter of this paragraph is mentioned in the specification as ‘A49’.

Preferably, the composition is as disclosed in any one of A40 to A45 or as in any combination derived from the disclosure in this section and the entire specification including the claims, wherein the composition does not comprise an oligosaccharide. The subject matter of this paragraph is mentioned in the specification as ‘A50’.

Preferably, the composition is as disclosed in any one of A40 to A45 or as in any combination derived from the disclosure in this section and the entire specification including the claims, wherein the composition does not comprise a polysaccharide (e.g. starch, carrageenan). The subject matter of this paragraph is mentioned in the specification as ‘A51’.

Preferably, the composition is as disclosed in any one of A40 to A45 or as in any combination derived from the disclosure in this section and the entire specification including the claims, wherein the composition does not comprise an acrylate monomer. The subject matter of this paragraph is mentioned in the specification as ‘A52’.

Preferably, the composition is as disclosed in any one of A40 to A45 or as in any combination derived from the disclosure in this section and the entire specification including the claims, wherein the composition does not comprise a methacrylate monomer. The subject matter of this paragraph is mentioned in the specification as ‘A53’.

Preferably, the composition is as disclosed in any one of A40 to A45 or as in any combination derived from the disclosure in this section and the entire specification including the claims, wherein the composition does not comprise a polyacrylate. The subject matter of this paragraph is mentioned in the specification as ‘A54’.

Preferably, the composition is as disclosed in any one of A40 to A45 or as in any combination derived from the disclosure in this section and the entire specification including the claims, wherein the composition does not comprise a polymethacrylate. The subject matter of this paragraph is mentioned in the specification as ‘A55’.

Preferably, the composition is as disclosed in any one of A40 to A45 or as in any combination derived from the disclosure in this section and the entire specification including the claims, wherein the composition does not comprise a poly(acrylate-methacrylate). The subject matter of this paragraph is mentioned in the specification as ‘A56’.

Preferably, the composition is as disclosed in any one of A40 to A45 or as in any combination derived from the disclosure in this section and the entire specification including the claims, wherein the composition does not comprise acrylamide. The subject matter of this paragraph is mentioned in the specification as ‘A57’.

Preferably, the composition is as disclosed in any one of A40 to A45 or as in any combination derived from the disclosure in this section and the entire specification including the claims, wherein the composition does not comprise maleic anhydride. The subject matter of this paragraph is mentioned in the specification as ‘A58’.

Preferably, the composition is as disclosed in any one of A40 to A45 or as in any combination derived from the disclosure in this section and the entire specification including the claims, wherein the composition does not comprise a glyceride. The subject matter of this paragraph is mentioned in the specification as ‘A59’.

Preferably, the composition is as disclosed in any one of A40 to A45 or as in any combination derived from the disclosure in this section and the entire specification including the claims, wherein the composition does not comprise cellulose. The subject matter of this paragraph is mentioned in the specification as ‘A60’.

Preferably, the composition is as disclosed in any one of A40 to A45 or as in any combination derived from the disclosure in this section and the entire specification including the claims, wherein the composition does not comprise chitosan. The subject matter of this paragraph is mentioned in the specification as ‘A61’.

Preferably, the composition is as disclosed in any one of A40 to A45 or as in any combination derived from the disclosure in this section and the entire specification including the claims, wherein the composition does not comprise silk fibroin. The subject matter of this paragraph is mentioned in the specification as ‘A62’.

Preferably, the composition is as disclosed in any one of A40 to A45 or as in any combination derived from the disclosure in this section and the entire specification including the claims, wherein the composition does not comprise hyaluronic acid. The subject matter of this paragraph is mentioned in the specification as ‘A63’.

Preferably, the composition is as disclosed in any one of A40 to A45 or as in any combination derived from the disclosure in this section and the entire specification including the claims, wherein the composition does not comprise fibrin. The subject matter of this paragraph is mentioned in the specification as ‘A64’.

Preferably, the composition is as disclosed in any one of A40 to A45 or as in any combination derived from the disclosure in this section and the entire specification including the claims, wherein the composition does not comprise collagen. The subject matter of this paragraph is mentioned in the specification as ‘A65’.

Preferably, the composition is as disclosed in any one of A40 to A45 or as in any combination derived from the disclosure in this section and the entire specification including the claims, wherein the composition does not comprise xanthan. The subject matter of this paragraph is mentioned in the specification as ‘A66’.

Preferably, the composition is as disclosed in any one of A40 to A45 or as in any combination derived from the disclosure in this section and the entire specification including the claims, wherein the composition does not comprise alginate. The subject matter of this paragraph is mentioned in the specification as ‘A67’.

Preferably, the composition is as disclosed in any one of A40 to A45 or as in any combination derived from the disclosure in this section and the entire specification including the claims, wherein the composition does not comprise pectin. The subject matter of this paragraph is mentioned in the specification as ‘A68’.

The compositions as disclosed in any one of A40 to A68 or as in any combination derived from the disclosure in this section and the entire specification including the claims, can be prepared for example by a process comprising the following steps: a) providing one or both of the superabsorbent polymer as the latter is disclosed in any one of A0 to A31 or the superabsorbent polymer obtained by the process as disclosed in any one of A32 to A33, or as in any combination derived from the disclosure in this section and the entire specification including the claims, and the particles as the latter are disclosed in any one of A34 to A39, or as in any combination derived from the disclosure in this section and the entire specification including the claims, and b) bringing in contact e.g. mixing, and/or immersing, the superabsorbent polymer and/or the particles with the another ingredient; for example, if the another ingredient is as described in any one of A42 to A43, then the composition as disclosed in any one of A40 to 68 or as in any combination derived from the disclosure in this section and the entire specification including the claims, can be prepared for example by a process comprising the following steps: a) providing one or both of the superabsorbent polymer as the latter is disclosed in any one of A0 to A31 or the superabsorbent polymer obtained by the process as disclosed in any one of A32 to A33, or as in any combination derived from the disclosure in this section and the entire specification including the claims, and the particles as the latter are disclosed in any one of A34 to A39 or as in any combination derived from the disclosure in this section and the entire specification including the claims, and b) immersing the superabsorbent polymer and/or the particles into the another ingredient, preferably for at least 1, more preferably at least 5, most preferably at least 10, for example at least 15, for example at least 30, for example at least 45, for example at least 60, for example at most 2880, for example at most 1440, for example at most 300, for example at most 240, for example at most 180, for example at most 120 min, for example at least 15 and at most 300 min, for example at least 30 and at most 300 min, for example at least 40 and at most 300 min, for example at least 40 and at most 180 min, for example at least 60 and at most 180 min, for example at least 60 and at most 120 min, for example 60 min. The subject matter of this paragraph is mentioned in the specification as ‘A69’.

In an embodiment of the invention, there is provided a use of:
the superabsorbent polymer as the latter is disclosed in any one of A0 to A31 or as in any combination derived from the disclosure in this section and the entire specification including the claims, or
the particles as the latter are disclosed in any one of A34 to A39 or as in any combination derived from the disclosure in this section and the entire specification including the claims, or
a composition as disclosed in any one of A40 to A69 or as in any combination derived from the disclosure in this section and the entire specification including the claims, in agricultural and horticultural applications, in personal hygiene applications, in construction and engineering applications, in environmental management applications, in packaging materials, in filtration applications, in paper applications, in cosmetics, in paints and coatings, in adhesives, in inks, in adsorption applications, in drug delivery, in transplants, in injectables, in biomedical devices, in wound healing, in wound dressing, in tissue engineering, in gene delivery, in vocal cord replacement materials, in contact lenses, in eye drops, in eye ointments, in diagnostics, in microarrays, in immunoisolation, in bioadhesives, and in the preparation of biomedical and pharmaceutical compositions.

Examples of agricultural and horticultural applications include but are not limited to materials for soil conditioning, materials for plant growth. Examples of adsorption applications include but are not limited to the adsorption of water-soluble contaminants such as dyes, metallic impurities, and biomolecules. Examples of biomedical devices include but are not limited to artificial organs, artificial muscle formation, biosensors. Examples of tissue engineering include but are not limited to artificial skin, human organ reconstruction material. Examples of injectables include but are not limited to injectables for tumor therapy. Examples of personal hygiene applications include but are not limited to diapers, sanitary napkins, feminine products. Examples of construction and engineering applications include but are not limited to compositions for self-healing concrete. Examples of environmental management applications include but are not limited to the cleaning up and retaining water from oil spills. Examples of packaging materials include but are not limited to the packaging of sensitive electronic components. Example of paper applications include but are not limited to pulp processing, paper processing, paper coatings. The subject matter of this paragraph is mentioned in the specification as ‘A70’.

Further preferments and embodiments of the invention and preferred features thereof are given in the claims.

Unless otherwise explicitly stated, any feature, element, component, embodiment, range and especially any preferred feature, preferred element, preferred embodiment, preferred range, preferred combination of ranges, preferment described in the entire specification can be combined with each other. Unless otherwise explicitly stated, any feature, element, component, embodiment, range and especially any preferred feature, preferred element, preferred embodiment, preferred range, preferred combination of ranges, preferments, and embodiments of the invention as these are disclosed in this section, in the claims and in the entire specification can be combined with each other. Unless otherwise explicitly stated, any feature, element, component, embodiment, range and especially any preferred feature, preferred element, preferred embodiment, preferred range, preferred combination of ranges, preferments, and embodiments in connection with any piece of disclosure in any one of A0 to A70 disclosed in this section can be combined with each other and with any other feature, element, component, embodiment, range and especially any preferred feature, preferred element, preferred embodiment, preferred range, preferred combination of ranges, preferments, and embodiments of the invention as these are disclosed in the entire specification including the claims.

### EXAMPLES & METHODS

The invention is explained in more detail with reference to the following non-limiting examples which are by way of illustration only.

In the Examples section:
the abbreviation ‘InvSAP’ (followed by an indexing number) represents an inventive SAP;
the abbreviation ‘CompSAP’ (followed by an indexing number) represents a comparative SAP.

By ‘inventive example’ or equally ‘inventive SAP’ is meant in the specification, an example or equally a SAP that is according to the invention.

By ‘comparative example’ or equally ‘comparative SAP’ is meant in the specification, an example or equally a SAP that is not according to the invention.

Unless otherwise stated, all the examples shown in this section were carried out in a controlled laboratory environment having a temperature of 23±1° C. (herein ‘room temperature’), atmospheric pressure (1 atm=101325 Pa), relative humidity of 50±1%, and airflow of ≤0.1 m/s.

### 1.1. Chemicals, Raw Materials and Other Materials Used in the Examples

Citric acid (purity 99.5%), mono-sodium citrate (purity 99%), glycerol (purity 99.5%), 1,4-butanediol (purity 99%) and hexamethylene diisocyanate (purity 99%) (abbreviated as HDI) were obtained from Sigma Aldrich and were used as supplied.

### 1.2. Determination of the Acid Value

The acid value (abbreviated as AV) was measured titrimetrically according to ISO 2114-2000. The acid value is given as the mass of potassium hydroxide (KOH) in milligrams that is required to neutralize one gram of the tested substance.

### 1.3. Determination of the Glass Transition Temperature

The glass transition temperature of the SAPs was determined by Dynamic Mechanical Thermal Analysis (abbreviated as DMTA) according to the following procedure:

Dynamic Mechanical Thermal Analyses have been performed using a Physica MCR302 rheometer equipped with an 8 mm diameter plate/plate geometry. The temperature was controlled by a Peltier hood and a Peltier bottom plate. The sample was dried for 48 hours under vacuum at 50° C. to remove residual moisture and it was subsequently pulverized to obtain a powder. The (powder) sample was positioned on the bottom plate of the apparatus which bottom plate was preheated at 170° C. Subsequently, the upper plate was slowly lowered to compress the sample with a normal force of 10 N; the amount of sample positioned between the plates was such to result into a compressed sample height of 0.5 mm. After a few minutes, when the normal force applied no longer resulted into no further compression, the actual DMTA measurement commenced. The compressed sample was subjected to an oscillatory shear deformation γ(t) with an amplitude (γₒ) of 0.05% and a frequency of 1 Hz via the upper plate. The amplitude of the resulting oscillatory shear stress τ(t) is referred as τₒ. The phase shift between the oscillating stress and the oscillating deformation is referred as δ. Under nitrogen atmosphere, the phase shift 8 was recorded as a function of temperature under nitrogen atmosphere while the compressed sample was cooled down from 170 to 20° C. at a rate of 4° C./min, while both oscillation and compression continued to apply. The T_{g} is defined as the temperature at which the phase shift 8 presents local maxima (if the SAP had more than one T_{g}) or where the phase shift 8 is at its maximum (if the SAP had only one T_{g}).

This method is abbreviated in the specification as DMTA-Tg.

### 1.4. Determination of the Decomposition Temperature

The decomposition temperature (T_{dec}) of the SAPs was determined by Thermogravimetric Analysis (abbreviated as TGA) using a TGA5500 supplied by TA Instruments calibrated with nickel and alumel standards on the basis of their Curie temperatures (temperature calibration) according to the following procedure:

The sample was dried for 48 hours under vacuum at 50° C. to remove residual moisture and it was subsequently pulverized to obtain a powder. 5 mg sample were used for the TGA and were placed in an open aluminum pan. The thermograph (or also known as TG curve) (x axis: temperature; y axis: mass) was recorded at a heating rate of 10° C./min, heating the sample up under a nitrogen atmosphere from 30° C. to 550° C. The T_{dec} is defined as the temperature at the point of intersection of the starting-mass baseline and the tangent to the TG curve at the point of maximum gradient. This definition of the T_{dec} was derived from paragraph 9.3.1 of DIN EN ISO 11358-1:2022; in this paragraph the T_{dec} is the temperature indicated as ‘A starting point’ in paragraph 9.3.1 of DIN EN ISO 11358-1:2022.

### 1.5. Determination of the Rubbery Plateau and the Rubbery Plateau Storage Modulus (Abbreviated as G′ₚ) at 160° C.

The rubbery plateau and the rubbery plateau storage modulus at 160° C. (abbreviated as G′ₚ) were determined by Dynamic Mechanical Thermal Analysis (abbreviated as DMTA) according to the following procedure:

Dynamic Mechanical Thermal Analyses have been performed using a Physica MCR302 rheometer equipped with an 8 mm diameter plate/plate geometry. The temperature was controlled by a Peltier hood and a Peltier bottom plate. The sample was dried for 48 hours under vacuum at 50° C. to remove residual moisture and it was subsequently pulverized to obtain a powder. The (powder) sample was positioned on the bottom plate of the apparatus which bottom plate was preheated at 170° C. Subsequently, the upper plate was slowly lowered to compress the sample with a normal force of 10 N; the amount of sample positioned between the plates was such to result into a compressed sample height of 0.5 mm. After a few minutes, when the normal force applied no longer resulted into no further compression, the actual DMTA measurement commenced. The compressed sample was subjected to an oscillatory shear deformation γ(t) with an amplitude (γₒ) of 0.05% and a frequency of 1 Hz via the upper plate. The amplitude of the resulting oscillatory shear stress τ(t) is referred as τₒ. The amplitude of the resulting oscillatory shear stress τ(t) is referred as τₒ. The phase shift between the oscillating stress and the oscillating deformation is referred as δ. The storage modulus G′ which represents the elastic resistance against deformation, is a function of τₒ, γₒ and δ as shown below:

G′=sin δ*τₒ/γₒ

In order to determine the τₒ, γₒ and δ as a function of temperature via the DMTA measurement, the compressed sample under nitrogen atmosphere was cooled down from 170 to 20° C. at a rate of 4° C./min, while both oscillation and compression continued to apply. At temperatures higher than the glass transition temperature and prior to its decomposition, a SAP (which is a crosslinked polymer) behaves like a rubber and all elastic resistance against deformation which is associated to the storage modulus G′ originates from the stretching of the three-dimensional network of crosslinked polymer chains.

By plotting the temperature (in ° C.) against the storage modulus G′, a) the rubbery plateau in case of a SAP (which is a crosslinker polymer) becomes evident (no rubbery plateau is recorded in case of a non-crosslinker polymer), and b) the storage modulus G′ at a specific temperature can be determined.

The rubbery plateau storage modulus G′ₚ which is the storage modulus G′ at 160° C. and which temperature 160° C. temperature lies on the rubbery plateau, is determined from the above mentioned plot of temperature against the storage modulus G′, at 160° C. This method is abbreviated in the specification as DMTA-G.

### 1.6. Determination of the Amounts of Citric Component, Multi-Functional Component and Polyhydroxy Component

The amounts of the citric component, multi-functional component and polyhydroxy component were determined by a combination of chemolysis gas chromatography-mass spectroscopy (abbreviated as chemolysis GC-MS) and Nuclear Magnetic Resonance (NMR) spectroscopy as explained below.

At first chemolysis GC-MS is performed in order to afford a qualitative determination of the composition of a super absorbent polymer. The general procedure for chemolysis GC-MS is: weigh in a sample of 15 mg of dried superabsorbent polymer into a vial with screw cap; subsequently add 200 μl of a solution of tetramethylammonium hydroxide in methanol (25 wt % in methanol). Allow the sample to react in an ultrasonic bath for 60 minutes at 80° C. Afterwards, further dilute the sample solution with 1 ml of methanol. Afterwards, inject 1 μl of this solution in the GC-MS system [Shimadzu GC-2030 equipped with autosampler (liquid injection), programmed-temperature vaporizing (PTV) injector supplied by GL Science, OPTIC4 multi-mode GC inlet supplied by GL Science and a mass selective detector (MSD) type QP2020NX, as well as a column WCOT (supplied by Restek) 40 m*0.18 mm*id df=0.18 μm (Rxi 5Sil-MS)]. The PTV injector is rapidly heated to 400° C. The methylated hydroxyl groups and the methylated acid groups were identified by using the library present in the GCMS Realtime Analysis software package from Shimadzu. The following conditions represent a typical set up for the analysis in the GC-MS system:
GC heating program: equilibrate at 40° C. for 30 sec; then heat up from 40° C. up to 70° C. with a heating rate of 10° C./min, followed by subsequent heating from 70° C. up to 140° C. with a heating rate of 20° C./min, and further followed up by subsequent heating from 140° C. up to 310° C. with a heating rate of 30° C./min and finally equilibrate at 310° C. for 215 sec,

| total runtime: | 16 | min |
|---|---|---|
| helium flow: | 1.69 ml/min (38 cm/s) | |
| split ratio: | 1:40 | |
| Mass spectrometer | Transfer line 280° C. | |
| parameters: | | |
| Source | 220° | C. |
| Scan rate | 10 | scans/s |
| Scan area | 35-600 | m/z |
| Blanc time | 1.75 | μs. |

Subsequently, and once the qualitative determination of the composition of a superabsorbent was performed, NMR spectroscopy (both ¹H-NMR and and ¹³C-NMR) was performed in order to obtain the quantitative determination of the composition of the superabsorbent polymer, including determining the amounts of the citric component, multi-functional component and polyhydroxy component, in a Bruker Ascend™ 400 spectrometer equipped with a prodigy cryogenic probe. A sample (5 g) of the superabsorbent polymer were first hydrolyzed by mixing the sample of the superabsorbent polymer in 100 ml of an aqueous solution of potassium hydroxide (6 M in water). The mixture was kept at 105° C. under reflux conditions for 24 h. Afterwards the mixture was cooled to room temperature and it was neutralized with an aqueous solution of acetic acid (5 wt % in water), to pH=7. Subsequently, the sample was dried under vacuum oven at 105° C. for 24 hours. The dried sample (50 mg of dried sample for the 1H-NMR analysis and 150 mg of dried sample for the 13C-NMR analysis] was then dissolved in 0.5 ml of an appropriate deuterated solvent (e.g. D₂O, CDCl₃, dimethyl sulfoxide-d6 (DMSO), pyridine-d5) and the solution was transferred into a NMR tube that was inserted into the NMR apparatus mentioned above. The evaluation of the corresponding NMR spectra was performed via the ACD software package.

This method is abbreviated in the specification as chemolysis GC-MS/NMR.

### 1.7. Determination of the Amount of the Citrate Component

The amount of the citrate component was determined by inductively coupled plasma optical emission spectrometry (abbreviated as ICP-OES) as explained below.

The ICP-OES analyses were performed on the Optima 7000 DV inductively coupled plasma optical emission spectrometer from Perkin Elmer (equipped with a cyclonic hydrofluoric acid (HF) resistant spray chamber, concentric nebulizer and featured a solid state charge coupled device (CCD) array detector) (abbreviated as ICP-OES system), calibrated with high purity multi element standards (Cat. No.: 1.11355.0100 from Supelco) with a concentration of 1000 mg/kg (the acid content of these standards was matched (and must be matched) to the samples resulting in elemental concentrations ranging from 0.1 ppm to 1000 ppm). The settings for the measurement were as follows (Tygon® tubing mentioned below was supplied by Fischer Scientific):

| | |
|---|---|
| Parameter | Setting |

| Pump tubing for introducing the | Tygon ® orange/white | |
|---|---|---|
| sample into the nebulizer | | |
| Pump tubing for the drainage | Tygon ® white/white | |
| Spray chamber | glass cyclonic | |
| Nebulizer | glass concentric | |
| Centre tube | 2.0 | mm |
| Pump speed | 50 | rpm |
| Nebulizer gas flow (nitrogen) | 1 | l/min |
| Auxiliary gas flow (nitrogen or argon) | 1 | l/min |
| Coolant gas flow (e.g. nitrogen) | 25 | l/min |
| RF power | 1150 | W |
| Exposure time if in UV area | 15 | s |
| Exposure time if in Visible area | 5 | s |

| | |
|---|---|
| View mode | radial/axial |
| Purge gas | nitrogen |

A proper amount of sample is used dependent on the expected elemental concentrations with regards to the linear range of the calibration. In this instance (for the SAP samples shown in the Examples of the specification) 6 mg of a SAP sample were weighed into a 55 ml MARSXpress digestion vessel (Cat. No.: 574126, material: perfluoroalkoxy alkane; supplied by CEM Corp.) Subsequently, an appropriate aliquot of HNO₃ (65 v/v %) was added into the digestion vessel containing the SAP sample and then the vessel was sealed off and digested in a CEM-SP-d destruction microwave oven (supplied by CEM Corp.) at 200° C. for 15 minutes. Digestion is a standard procedure in analytical chemistry for the sample preparation and used in ICP-OES for this purpose; the basic principle of digestion is the oxidative destruction of the SAP sample in order to dissolve the substance to be determined by the ICP-OES system. After digestion, the contents were transferred into a volumetric flask and brought to 100 ml volume with ultrapure water before analysis. A peristaltic pump was subsequently used for the introduction of the digested sample into the ICP-OES system.

The ICP-OES system provides simultaneous recording and analysis of multiple element specific light emission wavelengths that are emitted after introduction of the sample into the plasma. The processing of the data recorded was carried out with the help of the software package WinLab32™ supplied by Perkin Elmer. The light emission wavelengths suitable for the lowest detection limit for lithium, sodium, potassium and silver are given below:

| Metal | Light emission wavelength (nm) |
|---|---|
| Lithium | 670.784 |
| Sodium | 589.595 |
| Potassium | 766.490 |
| Silver | 328.068 |

One may retrieve atomic spectroscopic information for the ICP-OES method as to the light emission wavelengths of lithium, sodium, potassium and silver for other detection limits—if necessary—from the relevant library included in the software package mentioned above.

In the case of the SAP samples shown in the Examples of the specification, the light emission wavelength used for the determination of sodium was 589.595 nm.

The samples were measured in duplicate and the average of the two measurements was reported. The amount of metal identified in the SAP sample is offered in wt % of metal in the SAP sample. Given the well-known atomic numbers of each of lithium, sodium, potassium and silver, the amount determination of the citric component, multi-functional component and polyhydroxy component, and subtracting two moles of water per molecule of citric component in order to calculate the theoretical molecular weight of the reacted citric component, one skilled in the art is able to calculate the mol % of the citrate component on superabsorbent absorbent polymer.

### 1.8. Determination of the Amount of Citric Acid Component

The amount of the citric acid component, in mol % on superabsorbent polymer, is calculated by subtracting the amount of the citrate component in mol % on superabsorbent polymer determined by ICP-OES, from the amount of the citric component in mol % on superabsorbent polymer determined by chemolysis GC-MS/NMR.

### 1.9. Determination of the Shear Viscosity

The shear viscosity (in Pa·s) was determined according to the ISO 3219-2:2021, at a temperature of 130° C., using a cone spindle CAP-S-05 (19.5 mm, 1.8°) at 21 rpm and a shear rate of 70 sec-1.

### 1.10. Determination of the Particle Size of Particles-Sieve Analysis

The particle size of particles comprising or consisting of a superabsorbent polymer was determined by sieve analysis, as explained below.

10 g of sample (that is particles comprising or consisting of a superabsorbent polymer) were brought onto a Fritsch Analysette 3 Spartan sieving apparatus and they were placed onto a 6.30 mm sieve. The sample was sieved for 15 minutes at a 2.5 mm amplitude. The weight fraction of the sample which remained on the sieve was weighed after sieving (collected weight fraction). The weight fraction of the sample that went through the sieve (sieved weight fraction) was collected and was placed onto a 2.80 mm sieve and was sieved as mentioned just previously in this paragraph. Once the same measurements (weighing) were performed as mentioned just previously in this paragraph, the same procedure was repeated further using sequentially a 1.60, 1.00, 0.63, 0.35, 0.20, 0.09, and a 0.04 mm sieve; the last sieved fraction with a particle size smaller than 0.04 mm was also weighed. The values of the various collected weight fractions determined (vertical Y-axis) were plotted against their corresponding mesh sizes used (horizontal X-axis) and were best fitted in a curve; from the fitted curve the particle sizes of the sample corresponding to the 10 wt % and 90 wt % weight fractions of the sample were identified and reported.

### 1.11. Assessment of the Properties of SAPs

### 1.11.1. Determination of Water Absorptivity

A sample of 15 g was dried for 48 hours under vacuum at 50° C. to remove residual moisture and it was subsequently pulverized to obtain a powder. 10 g of the dried pulverized sample (M_{dry}) were suspended in a glass jar containing 1000 ml distilled water (pH=7) for 60 min. Immediately afterwards, the suspended sample was gravity filtrated via a 125 micron filter paper. When the dripping of the water through the filter paper stopped, and the sample was able to be held up vertically without slippage, the wet sample was weighted (M_{wet}).

The water absorptivity was subsequently calculated according to the following equation:

$$Water absorptivity ( \% ) = [ ( {M}_{w e t} - {M}_{d r y} ) / {M}_{d r y} ] * 100$$

wherein
M_{dry}=10 g and
M_{wet} is the mass of the wet sample in g.
   The values reported in the specification correspond to the average of three water absorptivity measurements per sample.

This method is mentioned in the specification as Water Absorptivity Method (abbreviated as WAM).

### 1.11.2. Determination of Biodegradability

The biodegradability after 90 days was determined according to ISO 14851:2019(E).

### 1.12. Preparation of SAPs According to the Invention (Inventive SAPs)

### 1.12.1. Preparation of InvSAP-1

### Synthesis of Precursor Polymer 1 (Abbreviated as PRPOL-1)

The synthesis of the precursor polymer 1 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (103.8 g, 0.54 mol), mono-sodium citrate (347.1 g, 1.62 mol), glycerol (199.1 g, 2.16 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-1; the PROPOL-1 was subsequently stored at room temperature in a desiccator under vacuum.

### Characterization of the PRPOL-1

The PRPOL-1 had an acid value of 186 mg KOH/g sample.

The PRPOL-1 had no rubbery plateau, thus it had no rubbery plateau storage modulus at 160° C.

### Preparation of the InvSAP-1

The PRPOL-1 was pulverized and it was subsequently heat-treated at 170° C. for 120 min according to the following procedure; 50 g of the PRPOL-1 were spread across an aluminum foil tray with a spatula to ensure an even distribution. This tray was then placed into a vacuum (50 mbar) oven at 170° C. for 120 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-1 which was subsequently pulverized into particles wherein 10 wt % of the particles had a particle size of at most 0.10, and 90 wt % of the particles had a particle size of at most 2.0 mm.

### Characterization of the InvSAP-1

T_{g}: 85° C., T_{dec}: 220° C., G′ₚ: 200 kPa; amount of citric component: 50 mol % on SAP (amount of citrate component: 23 mol %; amount of citric acid component: 27 mol %); amount of multi-functional component: 50 mol % on SAP.

### Properties of the InvSAP-1

The water absorptivity of the InvSAP-1 was 3400%.

The biodegradability of the InvSAP-1 was 73%.

### 1.12.2. Preparation of InvSAP-2

### Synthesis of Precursor Polymer 2 (Abbreviated as PRPOL-2)

The synthesis of the precursor polymer 2 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (84.6 g, 0.44 mol), mono-sodium citrate (119.8 g, 0.56 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-2; the PROPOL-2 was subsequently stored at room temperature in a desiccator under vacuum.

### Characterization of the PRPOL-2

The PRPOL-2 had an acid value of 182 mg KOH/g sample.

The PRPOL-2 had no rubbery plateau, thus it had no rubbery plateau storage modulus at 160° C.

### Preparation of the InvSAP-2

The PRPOL-2 was pulverized and it was subsequently heat-treated at 180° C. for 180 min according to the following procedure; 50 g of the PRPOL-2 were spread across an aluminum foil tray with a spatula to ensure an even distribution. This tray was then placed into a vacuum (50 mbar) oven at 180° C. for 180 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-2 which was subsequently pulverized into particles wherein 10 wt % of the particles had a particle size of at most 0.10, and 90 wt % of the particles had a particle size of at most 2.0 mm.

### Characterization of the InvSAP-2

T_{g}: 94° C., T_{dec}: 220° C., G′ₚ: 1000 kPa; amount of citric component: 50 mol % on SAP (amount of citrate component: 23 mol %; amount of citric acid component: 27 mol %); amount of multi-functional component: 50 mol % on SAP.

### Properties of the InvSAP-2

The water absorptivity of the InvSAP-2 was 2500%.

The biodegradability of the InvSAP-2 was 63%.

### 1.12.3. Preparation of InvSAP-3

### Synthesis of Precursor Polymer 3 (Abbreviated as PRPOL-3)

The synthesis of the precursor polymer 3 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (57.7 g, 0.30 mol), mono-sodium citrate (149.8 g, 0.70 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-3; the PROPOL-3 was subsequently stored at room temperature in a desiccator under vacuum.

### Characterization of the PRPOL-3

The PRPOL-3 had an acid value of 179 mg KOH/g sample.

The PRPOL-3 had no rubbery plateau, thus it had no rubbery plateau storage modulus at 160° C.

### Preparation of the InvSAP-3

The PRPOL-3 was pulverized and it was subsequently heat-treated at 170° C. for 120 min according to the following procedure; 50 g of the PRPOL-3 were spread across an aluminum foil tray with a spatula to ensure an even distribution. This tray was then placed into a vacuum (50 mbar) oven at 170° C. for 120 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-3 which was subsequently pulverized into particles wherein 10 wt % of the particles had a particle size of at most 0.10, and 90 wt % of the particles had a particle size of at most 2.0 mm.

### Characterization of the InvSAP-3

T_{g}: 100° C., T_{dec}: 220° C., G′ₚ: 800 kPa; amount of citric component: 49 mol % on SAP (amount of citrate component: 22 mol %; amount of citric acid component: 27 mol %); amount of multi-functional component: 51 mol % on SAP.

### Properties of the InvSAP-3

The water absorptivity of the InvSAP-3 was 2500%.

The biodegradability of the InvSAP-3 was 72%.

### 1.12.4. Preparation of InvSAP-4

### Synthesis of Precursor Polymer 4 (Abbreviated as PRPOL-4)

The synthesis of the precursor polymer 4 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (84.6 g, 0.44 mol), mono-sodium citrate (119.8 g, 0.56 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-4; the PROPOL-4 was subsequently stored at room temperature in a desiccator under vacuum.

### Characterization of the PRPOL-4

The PRPOL-4 had an acid value of 142 mg KOH/g sample.

The PRPOL-4 had no rubbery plateau, thus it had no rubbery plateau storage modulus at 160° C.

### Preparation of the InvSAP-4

The PRPOL-4 was pulverized and it was subsequently heat-treated at 160° C. for 120 min according to the following procedure; 50 g of the PRPOL-4 were spread across an aluminum foil tray with a spatula to ensure an even distribution. This tray was then placed into a vacuum (50 mbar) oven at 160° C. for 120 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-4 which was subsequently pulverized into particles wherein 10 wt % of the particles had a particle size of at most 0.10, and 90 wt % of the particles had a particle size of at most 2.0 mm.

### Characterization of the InvSAP-4

T_{g}: 128° C., T_{dec}: 230° C., G′ₚ: 460 kPa; amount of citric component: 49 mol % on SAP (amount of citrate component: 33 mol %; amount of citric acid component: 16 mol %); amount of multi-functional component: 51 mol % on SAP.

### Properties of the InvSAP-4

The water absorptivity of the InvSAP-4 was 3500%.

The biodegradability of the InvSAP-4 was 75%.

### 1.12.5. Preparation of InvSAP-5

### Synthesis of Precursor Polymer 5 (Abbreviated as PRPOL-5)

The synthesis of the precursor polymer 5 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (57.7 g, 0.30 mol), mono-sodium citrate (149.8 g, 0.70 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-5; the PROPOL-5 was subsequently stored at room temperature in a desiccator under vacuum.

Characterization of the PRPOL-5 The PRPOL-5 had an acid value of 167 mg KOH/g sample.

The PRPOL-5 had no rubbery plateau, thus it had no rubbery plateau storage modulus at 160° C.

### Preparation of the InvSAP-5

The PRPOL-5 was pulverized and it was subsequently heat-treated at 160° C. for 120 min according to the following procedure; 50 g of the PRPOL-5 were spread across an aluminum foil tray with a spatula to ensure an even distribution. This tray was then placed into a vacuum (50 mbar) oven at 160° C. for 120 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-5 which was subsequently pulverized into particles wherein 10 wt % of the particles had a particle size of at most 0.10, and 90 wt % of the particles had a particle size of at most 2.0 mm.

### Characterization of the InvSAP-5

T_{g}: 127° C., T_{dec}: 225° C., G′ₚ: 364 kPa; amount of citric component: 49 mol % on SAP (amount of citrate component: 33 mol %; amount of citric acid component: 16 mol %); amount of multi-functional component: 51 mol % on SAP.

### Properties of the InvSAP-5

The water absorptivity of the InvSAP-5 was 3500%.

The biodegradability of the InvSAP-5 was 77%.

### 1.12.6. Preparation of InvSAP-6

### Synthesis of Precursor Polymer 6 (Abbreviated as PRPOL-6)

The synthesis of the precursor polymer 6 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (84.6 g, 0.44 mol), mono-sodium citrate (119.8 g, 0.56 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-6; the PROPOL-6 was subsequently stored at room temperature in a desiccator under vacuum.

Characterization of the PRPOL-6 The PRPOL-6 had an acid value of 207 mg KOH/g sample.

The PRPOL-6 had no rubbery plateau, thus it had no rubbery plateau storage modulus at 160° C.

### Preparation of the InvSAP-6

The PRPOL-6 was pulverized and it was subsequently heat-treated at 170° C. for 120 min according to the following procedure; 50 g of the PRPOL-6 were spread across an aluminum foil tray with a spatula to ensure an even distribution. This tray was then placed into a vacuum (50 mbar) oven at 120° C. for 170 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-6 which was subsequently pulverized into particles wherein 10 wt % of the particles had a particle size of at most 0.10, and 90 wt % of the particles had a particle size of at most 2.0 mm.

### Characterization of the InvSAP-6

T_{g}: 85° C., T_{dec}: 220° C., G′ₚ: 300 kPa; amount of citric component: 50 mol % on SAP (amount of citrate component: 23 mol %; amount of citric acid component: 27 mol %); amount of multi-functional component: 50 mol % on SAP.

### Properties of the InvSAP-6

The water absorptivity of the InvSAP-6 was 3500%.

The biodegradability of the InvSAP-6 was 76%.

### 1.12.7. Preparation of InvSAP-7

### Synthesis of Precursor Polymer 7 (Abbreviated as PRPOL-7)

The synthesis of the precursor polymer 7 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (28.8 g, 0.15 mol), mono-sodium citrate (181.9 g, 0.85 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-7; the PROPOL-7 was subsequently stored at room temperature in a desiccator under vacuum.

### Characterization of the PRPOL7

The PRPOL-7 had an acid value of 231 mg KOH/g sample.

The PRPOL-7 had no rubbery plateau, thus it had no rubbery plateau storage modulus at 160° C.

### Preparation of the InvSAP-7

The PRPOL-7 was pulverized and it was subsequently heat-treated at 170° C. for 120 min according to the following procedure; 50 g of the PRPOL-7 were spread across an aluminum foil tray with a spatula to ensure an even distribution. This tray was then placed into a vacuum (50 mbar) oven at 120° C. for 170 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-7 which was subsequently pulverized into particles wherein 10 wt % of the particles had a particle size of at most 0.10, and 90 wt % of the particles had a particle size of at most 2.0 mm.

### Characterization of the InvSAP-7

T_{g}: 85° C., T_{dec}: 220° C., G′ₚ: 200 kPa; amount of citric component: 50 mol % on SAP (amount of citrate component: 34 mol %; amount of citric acid component: 16 mol %); amount of multi-functional component: 50 mol % on SAP.

### Properties of the InvSAP-7

The water absorptivity of the InvSAP-7 was 3400%.

The biodegradability of the InvSAP-7 was 76%.

### 1.12.8. Preparation of InvSAP-8

Synthesis of precursor polymer 5 (abbreviated as PRPOL-8) The synthesis of the precursor polymer 5 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (38.4 g, 0.20 mol), mono-sodium citrate (171.2 g, 0.80 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-8; the PROPOL-8 was subsequently stored at room temperature in a desiccator under vacuum.

Characterization of the PRPOL-8 The PRPOL-8 had an acid value of 177 mg KOH/g sample.

The PRPOL-8 had no rubbery plateau, thus it had no rubbery plateau storage modulus at 160° C.

### Preparation of the InvSAP-8

The PRPOL-8 was pulverized and it was subsequently heat-treated at 160° C. for 120 min according to the following procedure; 50 g of the PRPOL-8 were spread across an aluminum foil tray with a spatula to ensure an even distribution. This tray was then placed into a vacuum (50 mbar) oven at 160° C. for 120 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-8 which was subsequently pulverized into particles wherein 10 wt % of the particles had a particle size of at most 0.10, and 90 wt % of the particles had a particle size of at most 2.0 mm.

### Characterization of the InvSAP-8

T_{g}: 126° C., T_{dec}: 230° C., G′ₚ: 152 kPa; amount of citric component: 50 mol % on SAP (amount of citrate component: 34 mol %; amount of citric acid component: 16 mol %); amount of multi-functional component: 50 mol % on SAP.

### Properties of the InvSAP-8

The water absorptivity of the InvSAP-8 was 2500%.

The biodegradability of the InvSAP-8 was 76%.

### 1.12.9. Preparation of InvSAP-9

### Synthesis of Precursor Polymer 5 (Abbreviated as PRPOL-9)

The synthesis of the precursor polymer 5 was carried out via a one-pot melt polycondensation. A reaction vessel equipped with a nitrogen inlet, a heating mantle and a motorized stirrer running, a distillation bridge with a Claisen adapter, a condenser and a collection vessel was charged with citric acid (38.4 g, 0.20 mol), mono-sodium citrate (171.2 g, 0.80 mol), glycerol (92.1 g, 1 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified PRPOL-9; the PROPOL-9 was subsequently stored at room temperature in a desiccator under vacuum.

### Characterization of the PRPOL-9

The PRPOL-9 had an acid value of 199 mg KOH/g sample.

The PRPOL-9 had no rubbery plateau, thus it had no rubbery plateau storage modulus at 160° C.

### Preparation of the InvSAP-9

The PRPOL-9 was pulverized and it was subsequently heat-treated at 170° C. for 120 min according to the following procedure; 50 g of the PRPOL-8 were spread across an aluminum foil tray with a spatula to ensure an even distribution. This tray was then placed into a vacuum (50 mbar) oven at 170° C. for 120 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the InvSAP-9 which was subsequently pulverized into particles wherein 10 wt % of the particles had a particle size of at most 0.10, and 90 wt % of the particles had a particle size of at most 2.0 mm.

### Characterization of the InvSAP-9

T_{g}: 90° C., T_{dec}: 220° C., G′ₚ: 100 kPa; amount of citric component: 49 mol % on SAP (amount of citrate component: 29 mol %; amount of citric acid component: 20 mol %); amount of multi-functional component: 51 mol % on SAP.

### Properties of the InvSAP-9

The water absorptivity of the InvSAP-9 was 2500%.

The biodegradability of the InvSAP-9 was 75%.

### 1.13. Preparation of SAPs not According to the Invention (Comparative SAPs)

### 1.13.1. Preparation of CompSAP-1

### Synthesis of Precursor Polymer C1 (Abbreviated as CPRPOL-1)

The synthesis of the precursor polymer C1 was carried out via a one-pot melt polycondensation. A reaction vessel equipped with a nitrogen inlet, a heating mantle and a motorized stirrer running at 400 rpm, a distillation bridge with a Claisen adapter, a condenser and a collection vessel was charged with citric acid (314.2 g, 1.64 mol), 129.5 g mono-sodium citrate (129.5 g, 0.61 mol), 206.3 g glycerol (206.3 g, 2.24 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified CPRPOL-1; the CPROPOL-1 was subsequently stored at room temperature in a desiccator under vacuum.

### Characterization of the CPRPOL-1

The CPRPOL-1 had an acid value of 208 mg KOH/g of CPRPOL-1.

The CPRPOL-1 had no rubbery plateau, thus it had no rubbery plateau storage modulus at 160° C.

### Preparation of the CompSAP-1

The CPRPOL-1 was pulverized and it was subsequently heat-treated at 170° C. for 120 min according to the following procedure; 50 g of the CPRPOL-1 were spread across an aluminum foil tray with a spatula to ensure an even distribution. This tray was then placed into a vacuum (50 mbar) oven at 170° C. for 120 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the CompSAP-1 which was subsequently pulverized into particles wherein 10 wt % of the particles had a particle size of at most 0.10, and 90 wt % of the particles had a particle size of at most 2.0 mm.

### Characterization of the CompSAP-1

T_{g}: 110° C., T_{dec}: 225° C., G′ₚ: 6000 kPa; amount of citric component: 50 mol % on SAP (amount of citrate component: 13 mol %; amount of citric acid component: 37 mol %); amount of multi-functional component: 50 mol % on SAP.

### Properties of the CompSAP-1

The water absorptivity of the CompSAP-1 was 370%.

The biodegradability of the CompSAP-1 was 7%.

### 1.13.2. Preparation of CompSAP-3

### Synthesis of Precursor Polymer C3 (Abbreviated as CPRPOL-3)

The synthesis of the precursor polymer C3 was carried out via a one-pot melt polycondensation. A reaction vessel equipped with a nitrogen inlet, a heating mantle and a motorized stirrer running at 400 rpm, a distillation bridge with a Claisen adapter, a condenser and a collection vessel was charged with citric acid (57.7 g, 0.30 mol), 149.8 g mono-sodium citrate (149.8 g, 0.70 mol), 92.1 g glycerol (92.1 g, 1.0 mol) and 50 g demineralized water. The mixture was heated up to 130° C. (polycondensation temperature) whilst the shear viscosity of the mixture was monitored at regular and frequent time intervals by sampling of the reaction mixture and determining the shear viscosity. As soon as the shear viscosity reached 52 Pa·s, the mixture was removed from the reaction vessel by pouring it into another vessel which another vessel was at room temperature and allow it to cool down to obtain the solidified CPRPOL-3; the CPROPOL-3 was subsequently stored at room temperature in a desiccator under vacuum.

### Characterization of the CPRPOL-3

The CPRPOL-3 had an acid value of 144 mg KOH/g of CPRPOL-3.

The CPRPOL-3 had no rubbery plateau, thus it had no rubbery plateau storage modulus at 160° C.

### Preparation of the CompSAP-3

The CPRPOL-3 was pulverized and it was subsequently heat-treated at 160° C. for 60 min according to the following procedure; 50 g of the CPRPOL-1 were spread across an aluminum foil tray with a spatula to ensure an even distribution. This tray was then placed into a vacuum (50 mbar) oven at 160° C. for 60 min. Subsequently, the heating was switched off (the vacuum was maintained) and the obtained foam was allowed to cool down to room temperature; afterwards the vacuum was released and the sample (in the form of a foam) was removed from the oven and pulverized. Subsequently, the pulverized sample was put into a jar followed by the addition of 1000 g demineralized water in order for the sample to be washed with water for 24 h. Afterwards, the mixture was filtrated and the residue collected on the filter was dried in a vacuum (50 mbar) oven at 50° C. for 48 hours to obtain the CompSAP-3 which was subsequently pulverized into particles wherein 10 wt % of the particles had a particle size of at most 0.10, and 90 wt % of the particles had a particle size of at most 2.0 mm.

### Characterization of the CompSAP-3

T_{g}: 111° C., T_{dec}: 215° C., G′ₚ: 14 kPa; amount of citric component: 49 mol % on SAP (amount of citrate component: 27 mol %; amount of citric acid component: 24 mol %); amount of multi-functional component: 51 mol % on SAP.

### Properties of the CompSAP-1

The CompSAP-1 was not a superabsorbent polymer.

The water absorptivity of the CompSAP-1 was not determined because the CompSAP-3 was dissolved in water.

The biodegradability of the CompSAP-1 was 75%.

### 1.14. Other Examples not According to the Invention (Comparative Examples) as Reported in the Literature

### 1.14.1. Best Performing Example of H. J. Kim et al., Polymer Degradation and Stability, Vol. 144, (October 2017) p. 128-136.

The best performing SAP reported in H. J. Kim et al. in terms of water absorptivity had sample code PC_{0.7}N_{0.3}B_{1.5} consisted of citric acid in an amount of 28 mol % on superabsorbent polymer, mono-sodium citrate in an amount of 12 mol % on superabsorbent polymer and 1,4-butanediol in an amount of 60 mol % on superabsorbent polymer, and it was post-treated with HDI for 1.5 h at room temperature. The reported water absorptivity of this SAP (herein CompSAP-2) was 2130% (after 60 min at pH=7). No biodegradability results for this SAP were reported in the paper.

The inventors determined the biodegradability of CompSAP-2 (as the biodegradability is determined in the specification) and found it to be 3%.

### 1.15. Discussion of Results & Conclusion

The term ‘enhanced biodegradability’ as used in the specification means that the biodegradability (as determined in the specification) is at least 40%.

The term ‘enhanced water absorptivity’ as used in the specification means that the water absorptivity (as determined in the specification) is at least 1500%.

Table 1 summarizes the results on biodegradability and water absorptivity of the SAPs shown in the Examples section.

TABLE 1

| | Biodegradability (%) | Water absorptivity (%) |
|---|---|---|
| SAP | (90 days) | (60 min at pH = 7) |
| InvSAP-1 | 73 | 3400 |
| CompSAP-1 | 7 | 370 |
| CompSAP-2 | 3 | 2130* |
| CompSAP-3** | 74 | n.d.*** |
| InvSAP-2 | 63 | 2500 |
| InvSAP-3 | 72 | 2500 |
| InvSAP-4 | 75 | 3500 |
| InvSAP-5 | 77 | 3500 |
| InvSAP-6 | 76 | 3500 |
| InvSAP-7 | 76 | 3400 |
| InvSAP-8 | 76 | 2500 |
| InvSAP-9 | 75 | 2500 |

*value as reported in the prior art (see §1.14.1).
**CompSAP-3 was not a SAP.
***it was dissolved in water.

From the results shown in Table 1, it becomes evident that only the SAPs according to the invention (InvSAP-1 to InvSAP-9) combined both enhanced biodegradability and enhanced water absorptivity.

The CompSAP-1 (which has a G′ₚ of 6000 kPa) had neither enhanced biodegradability nor enhanced water absorptivity.

The CompSAP-3 (which had a G′ₚ of 14 kPa) was not a SAP (it was dissolved in water).

The CompSAP-2 (representing the state-of-the-art) had enhanced water absorptivity but it did not have enhanced biodegradability (actually it had extremely poor biodegradability).

From the results shown above and summarized in Table 1, it becomes evident that only the SAPs according to the claimed invention exhibited a unique combination of enhanced biodegradability and enhance water absorptivity.

Therefore, only the SAPs according to the claimed invention solved the technical problem which was the combination of enhanced biodegradability and enhanced water absorptivity.

1. A superabsorbent polymer which:
has one or more glass transition temperatures, determined by Dynamic Mechanical Thermal Analysis, and each one of the one or more glass transition temperatures is in the range of from and including 10 up to and including 140° C.,
has a decomposition temperature determined by Thermogravimetric Analysis, of at least 190 and at most 350° C.,
has a rubbery plateau storage modulus at 160° C. (abbreviated as G′ₚ), determined by Dynamic Mechanical Thermal Analysis, of at least 30 kPa and at most 5000 kPa, and
comprises in an amount of at least 80 and at most 100 mol % on superabsorbent polymer, reacted residues of a citric component and a multi-functional component,
wherein
the citric component is present in an amount of at least 40 and at most 75 mol % on superabsorbent polymer,
wherein
the citric component consists of a citrate component and a citric acid component,
and wherein
the citrate component is selected from the group consisting of mono-sodium citrate, mono-potassium citrate, mono-silver citrate, mono-lithium citrate, di-sodium citrate, di-potassium citrate, di-silver citrate, di-lithium citrate and mixtures thereof, and is present in an amount of at least 15 and at most 50 mol % on superabsorbent polymer,
and wherein
the citric acid component is selected from the group consisting of citric acid, citric acid anhydride, citric acid esters, and mixtures thereof, and is present in an amount of at least 15 and at most 50 mol % on superabsorbent polymer,
and wherein
the multi-functional component is present in an amount of at least 25, and at most 60 mol % on superabsorbent polymer,
and wherein
the multi-functional component consists of a polyhydroxy component and optionally of a component A which component A consists of one or both of a dihydroxy alcohol component and an amino-hydroxy component,
and wherein
the polyhydroxy component is selected from the group consisting of C₃-C₁₀ saturated aliphatic trihydroxy alcohols, C₅-C₁₄ saturated aliphatic tetrahydroxy alcohols, C₄-C₂₄ sugar alcohols, C₃-C₁₀ saturated aliphatic trihydroxy ethers, C₄-C₁₂ saturated aliphatic tetrahydroxy ethers, C₅-C₁₄ saturated aliphatic pentahydroxy ethers, C₆-C₁₆ saturated aliphatic hexahydroxy ethers, and mixtures thereof, and wherein
the polyhydroxy component is present in an amount of at least 25 and at most 60 mol % on superabsorbent polymer,
and wherein
the dihydroxy alcohol component is selected from the group consisting of C₂-C₁₂ saturated aliphatic dihydroxy alcohols and mixture thereof;
and wherein
the amino-hydroxy component is selected from the group consisting of C₂-C₁₄ saturated aliphatic secondary amines comprising two hydroxyl groups, C₃-C₂₀ saturated aliphatic tertiary amines comprising three hydroxyl groups, and mixtures thereof.

2. The superabsorbent polymer as claimed in claim 1, wherein the G′ₚ is at most 3000 kPa.

3. The superabsorbent polymer as claimed in claim 1, wherein the G′ₚ is at most 2000 kPa.

4. The superabsorbent polymer as claimed in claim 1, wherein the G′ₚ is at least 50 kPa.

5. The superabsorbent polymer as claimed in claim 1, wherein the G′ₚ is at least 80 kPa.

6. The superabsorbent polymer as claimed in claim 1, wherein the citric component is present in an amount of at least 40 and at most 60 mol % on superabsorbent polymer.

7. The superabsorbent polymer as claimed in claim 1, wherein the citrate component is present in an amount of at least 18 and at most 40 mol % on superabsorbent polymer.

8. The superabsorbent polymer as claimed in claim 1, wherein the citric acid component is present in an amount of at least 15 and at most 40 mol % on superabsorbent polymer.

9. A process for preparing a superabsorbent polymer as the superabsorbent polymer is claimed in claim 1, wherein the process comprises the steps of:
a) providing at least a citric component and a multi-functional component and optionally one or both of water and a polycondensation catalyst to afford a mixture,
b) mixing the mixture in a reaction vessel and polycondensing the mixture by heating at a temperature ranging from 110 to 180° C., for a time till the shear viscosity determined by the ISO 3219-2:2021 is 50±20 Pa·s,
c) removing the mixture out from the vessel, by pouring the mixture into another vessel and allow it to cool down to obtain a solidified precursor polymer,
d) collecting the precursor polymer,
e) optionally storing the precursor polymer at a temperature of at most 40° C., either in an inert gas atmosphere, or under vacuum, or under vacuum in an inert gas atmosphere,
f) heat-treating the precursor polymer at a temperature of at least 120 and at most 180° C. to afford the superabsorbent polymer,
g) optionally pulverizing the superabsorbent polymer,
h) optionally washing the superabsorbent polymer with excess water, then removing the water, and subsequently drying the superabsorbent polymer and afterwards optionally pulverizing the superabsorbent polymer.

10. Particles comprising a superabsorbent polymer as the superabsorbent polymer is claimed in claim 1.

11. A composition comprising: a) a superabsorbent polymer as the superabsorbent polymer is claimed in claim 1, and b) another ingredient.

12. The composition as claimed in claim 11, wherein the composition is a gel composition.

13. The composition as claimed in claim 11, wherein the composition is a hydrogel composition.

14. A method for preparing a product in agricultural and horticultural applications, in personal hygiene applications, in construction and engineering applications, in environmental management applications, in packaging materials, in filtration applications, in paper applications, in cosmetics, in paints and coatings, in adhesives, in inks, in adsorption applications, in drug delivery, in transplants, in injectables, in biomedical devices, in wound healing, in wound dressing, in tissue engineering, in gene delivery, in vocal cord replacement materials, in contact lenses, in eye drops, in eye ointments, in diagnostics, in microarrays, in immunoisolation, in bioadhesives, or in biomedical and pharmaceutical compositions, the method comprising providing the superabsorbent polymer as claimed in claim 1.
